(19) United States
(12) Patent Application Publication
(10) Pub. No.: US 2026/0270028 A1
(43) Pub. Date: Sep. 10, 2026

(54) METHOD AND DEVICE FOR MULTIPLE-POLARIZATION SIGNAL TRANSMISSION IN NON-TERRESTRIAL NETWORK

(71) Applicants: HYUNDAI MOTOR COMPANY, Seoul (KR); KIA CORPORATION, Seoul (KR); INHA UNIVERSITY RESEARCH AND BUSINESS FOUNDATION, Incheon (KR)

(72) Inventors: Young Kil Suh, Hwaseong-si, Gyeonggi-do (KR); Gene Back Hahn, Hwaseong-si, Gyeonggi-do (KR); Ui Hyun Hong, Hwaseong-si, Gyeonggi-do (KR); Duk Kyung Kim, Hwaseong-si, Gyeonggi-do (KR)

(73) Assignees: HYUNDAI MOTOR COMPANY, Seoul (KR); KIA CORPORATION, Seoul (KR); INHA UNIVERSITY RESEARCH AND BUSINESS FOUNDATION, Incheon (KR)

(21) Appl. No.: 18/875,629

(22) PCT Filed: Jul. 7, 2023
(86) PCT No.: PCT/KR2023/009628

§ 371 Date: Dec. 16, 2024

(30) Foreign Application Priority Data
Jul. 8, 2022 (KR) 10-2022-0084220

(51) Int. Cl. H04L 5/00; H04W 72/23; H04W 84/06

(52) U.S. Cl. CPC H04L 5/0094; H04L 5/0096; H04W 72/23; H04W 84/06

(57) ABSTRACT

An operation method of a satellite may comprise the steps of: if a predetermined condition is satisfied during communication with the satellite by using a first BWP among BWPs configured for a first UE, determining BWP switching to a second BWP among the BWPs; transmitting a BWP switching indication message including information on the second BWP to a second UE on the basis of the determination of the BWP switching; and communicating with the UE in the second BWP on the basis of the BWP switching indication message.

### TECHNICAL FIELD

The present disclosure relates to a polarization transmission technique in a non-terrestrial network, and more particularly, to a technique for using different polarizations for respective bandwidth parts (BWPs).

### BACKGROUND ART

A communication network (e.g. 5G communication network, 6G communication network, etc.) to provide enhanced communication services compared to the existing communication network (e.g. long term evolution (LTE), LTE-Advanced (LTA-A), etc.) is being developed. The 5G communication network (e.g. new radio (NR) communication network) can support not only a frequency band of 6 GHz or below, but also a frequency band of 6 GHz or above. That is, the 5G communication network can support a frequency range (FR1) band and/or FR2 band. The 5G communication network can support various communication services and scenarios compared to the LTE communication network. For example, usage scenarios of the 5G communication network may include enhanced Mobile BroadBand (eMBB), Ultra Reliable Low Latency Communication (URLLC), Massive Machine Type Communication (mMTC), and the like.

The 6G communication network can support a variety of communication services and scenarios compared to the 5G communication network. The 6G communication networks can meet the requirements of hyper-performance, hyper-bandwidth, hyper-space, hyper-precision, hyper-intelligence, and/or hyper-reliability. The 6G communication networks can support various and wide frequency bands and can be applied to various usage scenarios (e.g. terrestrial communication, non-terrestrial communication, sidelink communication, and the like).

The communication network (e.g. 5G communication network, 6G communication network, etc.) may provide communication services to terminals located on the ground. Recently, the demand for communication services for not only terrestrial but also non-terrestrial airplanes, drones, and satellites has been increasing, and for this purpose, technologies for a non-terrestrial network (NTN) have been discussed. The non-terrestrial network may be implemented based on 5G communication technology, 6G communication technology, and/or the like. For example, in the non-terrestrial network, communication between a satellite and a terrestrial communication node or a non-terrestrial communication node (e.g. airplane, drone, or the like) may be performed based on 5G communication technology, 6G communication technology, and/or the like. In the NTN, the satellite may perform functions of a base station in a communication network (e.g. 5G communication network, 6G communication network, and/or the like).

Meanwhile, as the standardization of New Radio (NR), the representative 5G communication technology, has rapidly progressed, commercialization is also taking place. The 3rd Generation Partnership Project (3GPP), the organization that defines NR standards, has been discussing the utilization of polarization characteristics in the non-terrestrial network (NTN) and has reached an agreement on the need for signaling of polarization characteristics. Specifically, the 3GPP has agreed that polarization signaling in NTN should be conducted through a system information block (SIB). Additionally, the 3GPP has agreed that separate polarization information is required for both uplink and downlink in NTN. Furthermore, the 3GPP has agreed that polarization signaling is required in NTN for handovers and radio resource management (RRM) configurations.

If polarization is not a bandwidth part (BWP)-specific attribute in NTN, a transmitting node, i.e., a satellite, needs to indicate the polarization characteristics through additional signaling. Therefore, when the satellite performs polarization multiplexing in NTN, the need for polarization signaling for each terminal arises. In this case, it is expected that scenarios where polarization operates as a BWP-specific attribute in NTN will be prioritized. When polarization operates as a BWP-specific attribute, to support polarization-multiplexed transmission, it is necessary to change polarization characteristics and switch BWPs accordingly in NTN. Specifically, solutions for polarization and BWP switching or reconfiguration are required to support intra-UE polarization-multiplexed transmission and inter-UE polarization-multiplexed transmission.

### DISCLOSURE

### Technical Problem

The present disclosure is directed to providing a method and an apparatus for multi-polarization transmission in a non-terrestrial network.

### Technical Solution

A method of a satellite, according to the present disclosure for achieving the above-described objective, may comprise: in response to a predetermined condition being satisfied while a first user equipment (UE) communicates with the satellite using a first bandwidth part (BWP) among BWPs configured for the first UE, determining BWP switching to communicate using a second BWP; transmitting a BWP switching instruction message including information of the second BWP to the first UE, based on the determined BWP switching; switching a BWP for communicating with the first UE from the first BWP to the second BWP; and communicating with the first UE in the second BWP, based on the BWP switching instruction message, wherein in each of the BWPs, communication is performed with one of polarization types of a Right Hand Circular Polarization (RHCP), a Left Hand Circular Polarization (LHCP), RHCP/LHCP, a Horizontal-linear polarization (H-LP), a Vertical-linear polarization (V-LP), or a Horizontal/Vertical-linear polarization (H/V-LP).

The predetermined condition may include a case where at least a part of a frequency band of a third BWP communicating with a second UE other than the first UE overlaps with the first BWP, and polarization attributes of the third BWP and the first BWP are same.

The second BWP may be a BWP whose frequency band does not overlap with the third BWP.

The first BWP and the second BWP may have a same frequency band and different polarization attributes.

The BWP switching instruction message may be one of a radio resource control (RRC) reconfiguration message or downlink control information (DCI).

The method may further comprise: identifying whether the BWP switching is possible to one of BWPs configured for the first UE when a third BWP of a second UE, other than the first UE, overlaps at least a part of a frequency band of the second BWP and has a same polarization attribute as the second BWP; reconfiguring the BWPs configured for the first UE when the BWP switching is impossible to any of the BWPs configured for the first UE; and transmitting a higher layer message including configuration information of the reconfigured BWPs to the first UE.

At least one of a frequency bandwidth or polarization attribute of at least one BWP among the reconfigured BWPs may be different from that of other BWPs among the reconfigured BWPs.

A method of a first user equipment (UE), according to the present disclosure for achieving the above-described objective, may comprise: receiving configuration information of bandwidth parts (BWPs) configured for the first UE from a satellite; receiving a BWP switching instruction message including information of a second BWP while communicating with the satellite using a first BWP included in the BWPs; and communicating with the satellite in the second BWP based on the BWP switching instruction message, wherein in each of the BWPs, communication is performed with one of polarization types of a Right Hand Circular Polarization (RHCP), a Left Hand Circular Polarization (LHCP), RHCP/LHCP, a Horizontal-linear polarization (H-LP), a Vertical-linear polarization (V-LP), or a Horizontal/Vertical-linear polarization (H/V-LP).

The first BWP and the second BWP may have a same frequency band and different polarization attributes.

The BWP switching instruction message may be one of a radio resource control (RRC) reconfiguration message or downlink control information (DCI).

The method may further comprise: upon receiving a reconfiguration message for the BWPs from the satellite, reconfiguring BWPs capable of communicating with the satellite based on the received reconfiguration message; and when a third BWP among the reconfigured BWPs is instructed to communicate with the satellite, communicating with the satellite in the third BWP.

At least one of a frequency bandwidth or polarization attribute of at least one BWP among the reconfigured BWPs may be different from that of other BWPs among the reconfigured BWPs.

A satellite, according to the present disclosure for achieving the above-described objective, may comprise a processor, and the processor may cause the satellite to perform: in response to a predetermined condition being satisfied while a first user equipment (UE) communicates with the satellite using a first bandwidth part (BWP) among BWPs configured for the first UE, determining BWP switching to communicate using a second BWP; transmitting a BWP switching instruction message including information of the second BWP to the first UE, based on the determined BWP switching; switching a BWP for communicating with the first UE from the first BWP to the second BWP; and communicating with the first UE in the second BWP, based on the BWP switching instruction message, wherein in each of the BWPs, communication is performed with one of polarization types of a Right Hand Circular Polarization (RHCP), a Left Hand Circular Polarization (LHCP), RHCP/LHCP, a Horizontal-linear polarization (H-LP), a Vertical-linear polarization (V-LP), or a Horizontal/Vertical-linear polarization (H/V-LP).

The predetermined condition may include a case where at least a part of a frequency band of a third BWP communicating with a second UE other than the first UE overlaps with the first BWP, and polarization attributes of the third BWP and the first BWP are same.

The second BWP may be a BWP whose frequency band does not overlap with the third BWP.

The first BWP and the second BWP may have a same frequency band and different polarization attributes.

The BWP switching instruction message may be one of a radio resource control (RRC) reconfiguration message or downlink control information (DCI).

The processor may further cause the satellite to perform: identifying whether the BWP switching is possible to one of BWPs configured for the first UE when a third BWP of a second UE, other than the first UE, overlaps at least a part of a frequency band of the second BWP and has a same polarization attribute as the second BWP; reconfiguring the BWPs configured for the first UE when the BWP switching is impossible to any of the BWPs configured for the first UE; and transmitting a higher layer message including configuration information of the reconfigured BWPs to the first UE.

At least one of a frequency bandwidth or polarization attribute of at least one BWP among the reconfigured BWPs may be different from that of other BWPs among the reconfigured BWPs.

### Advantageous Effects

According to the present disclosure, a satellite communicating with UE(s) can actively switch BWPs or change a polarization attribute of a BWP based on the polarization characteristics. As a result, the satellite can utilize frequency resources more efficiently. Furthermore, the satellite can reduce interference during communication with the UE(s), thereby improving data transmission efficiency.

### DESCRIPTION OF DRAWINGS

FIG. 1A is a conceptual diagram illustrating a first exemplary embodiment of a non-terrestrial network.

FIG. 1B is a conceptual diagram illustrating a second exemplary embodiment of a non-terrestrial network.

FIG. 2A is a conceptual diagram illustrating a third exemplary embodiment of a non-terrestrial network.

FIG. 2B is a conceptual diagram illustrating a fourth exemplary embodiment of a non-terrestrial network.

FIG. 2C is a conceptual diagram illustrating a fifth exemplary embodiment of a non-terrestrial network.

FIG. 3 is a block diagram illustrating a first exemplary embodiment of a communication node constituting a non-terrestrial network.

FIG. 4 is a block diagram illustrating a first exemplary embodiment of communication nodes performing communication.

FIG. 5A is a block diagram illustrating a first exemplary embodiment of a transmission path.

FIG. 5B is a block diagram illustrating a first exemplary embodiment of a reception path.

FIG. 6A is a conceptual diagram illustrating a first exemplary embodiment of a protocol stack of a user plane in a transparent payload-based non-terrestrial network.

FIG. 6B is a conceptual diagram illustrating a first exemplary embodiment of a protocol stack of a control plane in a transparent payload-based non-terrestrial network.

FIG. 7A is a conceptual diagram illustrating a first exemplary embodiment of a protocol stack of a user plane in a regenerative payload-based non-terrestrial network.

FIG. 7B is a conceptual diagram illustrating a first exemplary embodiment of a protocol stack of a control plane in a regenerative payload-based non-terrestrial network.

FIG. 8A is a conceptual diagram of a case where a frequency reuse factor is 1.

FIG. 8B is a conceptual diagram of a case where a frequency reuse factor is 3.

FIG. 8C is a conceptual diagram of a case where a frequency reuse factor is 4.

FIG. 9 is a conceptual diagram illustrating a first exemplary embodiment of BWPs used in an RRC idle state and an RRC connected state of a UE.

FIG. 10A is an exemplary diagram describing BWP switching with three BWPs.

FIG. 10B is a diagram illustrating BWP-related configurations in a serving cell configuration information element ServingCellConfig of an RRC message.

FIG. 11A is a conceptual diagram of a case where a satellite performs polarization-multiplexed transmission to a UE in NTN.

FIG. 11B is a conceptual diagram of a case where a satellite performs single-polarization transmission to a UE in NTN.

FIG. 12A is a conceptual diagram of a case where four BWPs are allocated to UE1.

FIG. 12B is a conceptual diagram of a case where switching is performed to a BWP having a different polarization attribute.

FIG. 12C is a conceptual diagram of a case where only a BWP polarization attribute is switched through DCI signaling.

FIG. 13A is a conceptual diagram describing a method for supporting inter-UE polarization-multiplexed transmission in NTN.

FIG. 13B is a conceptual diagram describing allocation of BWPs during inter-UE polarization-multiplexed transmission in NTN.

FIG. 14A is an exemplary diagram of a case where four BWPs are allocated to each of UE 1 and UE 2 in NTN.

FIG. 14B is an exemplary diagram describing a case where UE 1 and UE 2 communicate in specific BWPs in NTN.

FIG. 14C is an exemplary diagram describing a case where BWP switching is performed in one of UEs in NTN.

FIG. 15A is another exemplary diagram describing a case where the UE 1 and UE 2 communicate in a specific BWP among four BWPs in NTN.

FIG. 15B is another exemplary diagram describing a case where UE 1 and UE 2 communicate in specific BWPs in NTN.

FIG. 15C is an exemplary diagram describing a case where BWP polarization attribute switching is performed in one of the UEs in NTN.

FIG. 16A is an exemplary diagram describing a case where four BWPs are allocated to each of the UE 1 and UE 2 in NTN.

FIG. 16B is an exemplary diagram describing a case of reconfiguring a BWP of the UE 1 in the NTN.

FIG. 16C is an exemplary diagram describing a case where the UE 1 and UE 2 communicate in specific BWPs among the BWPs configured as in FIG. 16A.

FIG. 16D is an exemplary diagram describing a case where BWP switching is performed after BWP reconfiguration in one of the UEs in NTN.

### MODE FOR INVENTION

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In the present disclosure, “at least one of A and B” may mean “at least one of A or B” or “at least one of combinations of one or more of A and B”. Also, in exemplary embodiments of the present disclosure, “one or more of A and B” may mean “one or more of A or B” or “one or more of combinations of one or more of A and B”.

In the present disclosure, “(re) transmission” may refer to “transmission”, “retransmission”, or “transmission and retransmission”, “(re) configuration” may refer to “configuration”, “reconfiguration”, or “configuration and reconfiguration”, “(re) connection” may refer to “connection”, “reconnection”, or “connection and reconnection”, and “(re) access” may mean “access”, “re-access”, or “access and re-access”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

The terminology used herein is for the purpose of describing particular embodiments only and is not intended to be limiting of the present disclosure. As used herein, the singular forms are intended to include the plural forms as well, unless the context clearly indicates otherwise. It will be further understood that the terms “comprise” and/or “include” when used herein, specify the presence of stated features, integers, steps, operations, elements, components or combinations thereof, but do not preclude the presence or addition of one or more other features, integers, steps, operations, elements, components, and/or combinations thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted. In addition to the exemplary embodiments explicitly described in the present disclosure, operations may be performed according to a combination of the exemplary embodiments, extensions of the exemplary embodiments, and/or modifications of the exemplary embodiments. Performance of some operations may be omitted, and the order of performance of operations may be changed.

Even when a method (e.g. transmission or reception of a signal) performed at a first communication node among communication nodes is described, a corresponding second communication node may perform a method (e.g. reception or transmission of the signal) corresponding to the method performed at the first communication node. That is, when an operation of a user equipment (UE) is described, a base station corresponding to the UE may perform an operation corresponding to the operation of the UE. Conversely, when an operation of a base station is described, a UE corresponding to the base station may perform an operation corresponding to the operation of the base station. In a non-terrestrial network (NTN) (e.g. payload-based NTN), operations of a base station may refer to operations of a satellite, and operations of a satellite may refer to operations of a base station.

The base station may refer to a NodeB, evolved NodeB (eNodeB), next generation node B (gNodeB), gNB, device, apparatus, node, communication node, base transceiver station (BTS), radio remote head (RRH), transmission reception point (TRP), radio unit (RU), road side unit (RSU), radio transceiver, access point, access node, and/or the like. The UE may refer to a terminal, device, apparatus, node, communication node, end node, access terminal, mobile terminal, station, subscriber station, mobile station, portable subscriber station, on-broad unit (OBU), and/or the like.

In the present disclosure, signaling may be at least one of higher layer signaling, medium access control (MAC) signaling, or physical (PHY) signaling. Messages used for higher layer signaling may be referred to as ‘higher layer messages’ or ‘higher layer signaling messages’. Messages used for MAC signaling may be referred to as ‘MAC messages’ or ‘MAC signaling messages’. Messages used for PHY signaling may be referred to as ‘PHY messages’ or ‘PHY signaling messages’. The higher layer signaling may refer to a transmission and reception operation of system information (e.g. master information block (MIB), system information block (SIB)) and/or RRC messages. The MAC signaling may refer to a transmission and reception operation of a MAC control element (CE). The PHY signaling may refer to a transmission and reception operation of control information (e.g. downlink control information (DCI), uplink control information (UCI), and sidelink control information (SCI)).

In the present disclosure, “an operation (e.g. transmission operation) is configured” may mean that “configuration information (e.g. information element(s) or parameter(s)) for the operation and/or information indicating to perform the operation is signaled”. “Information element(s) (e.g. parameter(s)) are configured” may mean that “corresponding information element(s) are signaled”. In the present disclosure, “signal and/or channel” may mean a signal, a channel, or “signal and channel,” and “signal” may be used to mean “signal and/or channel”.

A communication system may include at least one of a terrestrial network, non-terrestrial network, 4G communication network (e.g. long-term evolution (LTE) communication network), 5G communication network (e.g. new radio (NR) communication network), or 6G communication network. Each of the 4G communications network, 5G communications network, and 6G communications network may include a terrestrial network and/or a non-terrestrial network. The non-terrestrial network may operate based on at least one communication technology among the LTE communication technology, 5G communication technology, or 6G communication technology. The non-terrestrial network may provide communication services in various frequency bands.

The communication network to which exemplary embodiments are applied is not limited to the content described below, and the exemplary embodiments may be applied to various communication networks (e.g. 4G communication network, 5G communication network, and/or 6G communication network). Here, a communication network may be used in the same sense as a communication system.

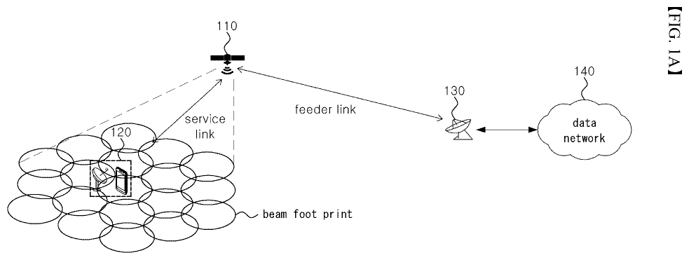

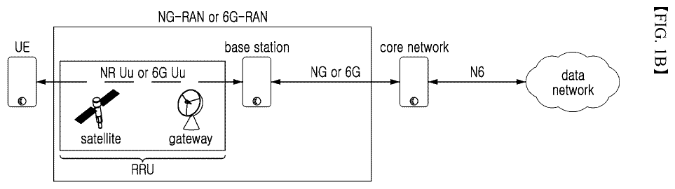

FIG. 1A is a conceptual diagram illustrating a first exemplary embodiment of a non-terrestrial network.

As shown in FIG. 1A, a non-terrestrial network (NTN) may include a satellite 110, a communication node 120, a gateway 130, a data network 140, and the like. A unit including the satellite 110 and the gateway 130 may correspond to a remote radio unit (RRU). The NTN shown in FIG. 1A may be an NTN based on a transparent payload. The satellite 110 may be a low earth orbit (LEO) satellite, a medium earth orbit (MEO) satellite, a geostationary earth orbit (GEO) satellite, a high elliptical orbit (HEO) satellite, or an unmanned aircraft system (UAS) platform. The UAS platform may include a high altitude platform station (HAPS). A non-GEO satellite may be an LEO satellite and/or MEO satellite.

The communication node 120 may include a communication node (e.g. a user equipment (UE) or a terminal) located on a terrestrial site and a communication node (e.g. an airplane, a drone) located on a non-terrestrial space. A service link may be established between the satellite 110 and the communication node 120, and the service link may be a radio link. The satellite 110 may provide communication services to the communication node 120 using one or more beams. The shape of a footprint of the beam of the satellite 110 may be elliptical or circular.

In the non-terrestrial network, three types of service links can be supported as follows.
Earth-fixed: a service link may be provided by beam(s) that continuously cover the same geographic area at all times (e.g. geosynchronous orbit (GSO) satellite).
quasi-earth-fixed: a service link may be provided by beam(s) covering one geographical area during a limited period and provided by beam(s) covering another geographical area during another period (e.g. non-GSO (NGSO) satellite forming steerable beams).
earth-moving: a service link may be provided by beam(s) moving over the Earth's surface (e.g. NGSO satellite forming fixed beams or non-steerable beams).

The communication node 120 may perform communications (e.g. downlink communication and uplink communication) with the satellite 110 using 4G communication technology, 5G communication technology, and/or 6G communication technology. The communications between the satellite 110 and the communication node 120 may be performed using an NR-Uu interface and/or 6G-Uu interface. When dual connectivity (DC) is supported, the communication node 120 may be connected to other base stations (e.g. base stations supporting 4G, 5G, and/or 6G functionality) as well as the satellite 110, and perform DC operations based on the techniques defined in 4G, 5G, and/or 6G technical specifications.

The gateway 130 may be located on a terrestrial site, and a feeder link may be established between the satellite 110 and the gateway 130. The feeder link may be a radio link. The gateway 130 may be referred to as a ‘non-terrestrial network (NTN) gateway’. The communications between the satellite 110 and the gateway 130 may be performed based on an NR-Uu interface, a 6G-Uu interface, or a satellite radio interface (SRI). The gateway 130 may be connected to the data network 140. There may be a ‘core network’ between the gateway 130 and the data network 140. In this case, the gateway 130 may be connected to the core network, and the core network may be connected to the data network 140. The core network may support the 4G communication technology, 5G communication technology, and/or 6G communication technology. For example, the core network may include an access and mobility management function (AMF), a user plane function (UPF), a session management function (SMF), and the like. The communications between the gateway 130 and the core network may be performed based on an NG-C/U interface or 6G-C/U interface.

As shown in an exemplary embodiment of FIG. 1B, there may be a ‘core network’ between the gateway 130 and the data network 140 in a transparent payload-based NTN.

FIG. 1B is a conceptual diagram illustrating a second exemplary embodiment of a non-terrestrial network.

As shown in FIG. 1B, the gateway may be connected with the base station, the base station may be connected with the core network, and the core network may be connected with the data network. Each of the base station and core network may support the 4G communication technology, 5G communication technology, and/or 6G communication technology. The communications between the gateway and the base station may be performed based on an NR-Uu interface or 6G-Uu interface, and the communications between the base station and the core network (e.g. AMF, UPF, SMF, and the like) may be performed based on an NG-C/U interface or 6G-C/U interface.

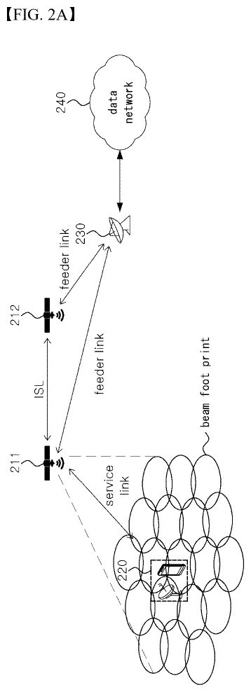

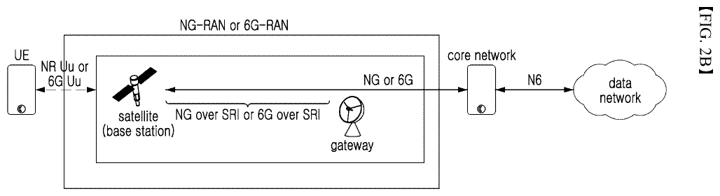

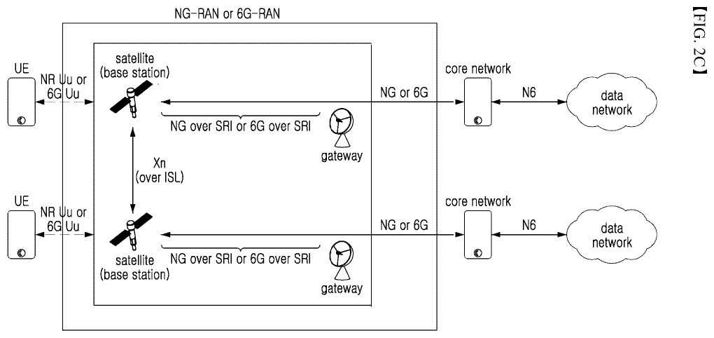

FIG. 2A is a conceptual diagram illustrating a third exemplary embodiment of a non-terrestrial network.

As shown in FIG. 2A, a non-terrestrial network may include a first satellite 211, a second satellite 212, a communication node 220, a gateway 230, a data network 240, and the like. The NTN shown in FIG. 2A may be a regenerative payload based NTN. For example, each of the satellites 211 and 212 may perform a regenerative operation (e.g. demodulation, decoding, re-encoding, re-modulation, and/or filtering operation) on a payload received from other entities (e.g. the communication node 220 or the gateway 230), and transmit the regenerated payload.

Each of the satellites 211 and 212 may be a LEO satellite, a MEO satellite, a GEO satellite, a HEO satellite, or a UAS platform. The UAS platform may include a HAPS. The satellite 211 may be connected to the satellite 212, and an inter-satellite link (ISL) may be established between the satellite 211 and the satellite 212. The ISL may operate in an RF frequency band or an optical band. The ISL may be established optionally. The communication node 220 may include a terrestrial communication node (e.g. UE or terminal) and a non-terrestrial communication node (e.g. airplane or drone). A service link (e.g. radio link) may be established between the satellite 211 and communication node 220. The satellite 211 may provide communication services to the communication node 220 using one or more beams.

The communication node 220 may perform communications (e.g. downlink communication or uplink communication) with the satellite 211 using the 4G communication technology, 5G communication technology, and/or 6G communication technology. The communications between the satellite 211 and the communication node 220 may be performed using an NR-Uu interface or 6G-Uu interface. When DC is supported, the communication node 220 may be connected to other base stations (e.g. base stations supporting 4G, 5G, and/or 6G functionality) as well as the satellite 211, and may perform DC operations based on the techniques defined in 4G, 5G, and/or 6G technical specifications.

The gateway 230 may be located on a terrestrial site, a feeder link may be established between the satellite 211 and the gateway 230, and a feeder link may be established between the satellite 212 and the gateway 230. The feeder link may be a radio link. When the ISL is not established between the satellite 211 and the satellite 212, the feeder link between the satellite 211 and the gateway 230 may be established mandatorily. The communications between each of the satellites 211 and 212 and the gateway 230 may be performed based on an NR-Uu interface, a 6G-Uu interface, or an SRI. The gateway 230 may be connected to the data network 240.

As shown in exemplary embodiments of FIG. 2B and FIG. 2C, there may be a ‘core network’ between the gateway 230 and the data network 240.

FIG. 2B is a conceptual diagram illustrating a fourth exemplary embodiment of a non-terrestrial network, and FIG. 2C is a conceptual diagram illustrating a fifth exemplary embodiment of a non-terrestrial network.

As shown in FIG. 2B and FIG. 2C, the gateway may be connected with the core network, and the core network may be connected with the data network. The core network may support the 4G communication technology, 5G communication technology, and/or 6G communication technology. For example. The core network may include AMF, UPF, SMF, and the like. Communication between the gateway and the core network may be performed based on an NG-C/U interface or 6G-C/U interface. Functions of a base station may be performed by the satellite. That is, the base station may be located on the satellite. A payload may be processed by the base station located on the satellite. Base stations located on different satellites may be connected to the same core network. One satellite may have one or more base stations. In the non-terrestrial network of FIG. 2B, an ISL between satellites may not be established, and in the non-terrestrial network of FIG. 2C, an ISL between satellites may be established.

Meanwhile, the entities (e.g. satellite, base station, UE, communication node, gateway, and the like) constituting the non-terrestrial network shown in FIGS. 1A, 1B, 2A, 2B, and/or 2C may be configured as follows. In the present disclosure, the entity may be referred to as a communication node.

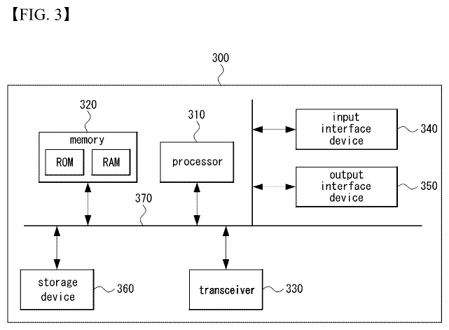

FIG. 3 is a block diagram illustrating a first exemplary embodiment of a communication node constituting a non-terrestrial network.

As shown in FIG. 3, a communication node 300 may include at least one processor 310, a memory 320, and a transceiver 330 connected to a network to perform communication. In addition, the communication node 300 may further include an input interface device 340, an output interface device 350, a storage device 360, and the like. The components included in the communication node 300 may be connected by a bus 370 to communicate with each other.

However, each component included in the communication node 300 may be connected to the processor 310 through a separate interface or a separate bus instead of the common bus 370. For example, the processor 310 may be connected to at least one of the memory 320, the transceiver 330, the input interface device 340, the output interface device 350, and the storage device 360 through a dedicated interface.

The processor 310 may execute at least one instruction stored in at least one of the memory 320 and the storage device 360. The processor 310 may refer to a central processing unit (CPU), a graphics processing unit (GPU), or a dedicated processor on which the methods according to the exemplary embodiments of the present disclosure are performed. Each of the memory 320 and the storage device 360 may be configured as at least one of a volatile storage medium and a nonvolatile storage medium. For example, the memory 320 may be configured with at least one of a read only memory (ROM) and a random access memory (RAM).

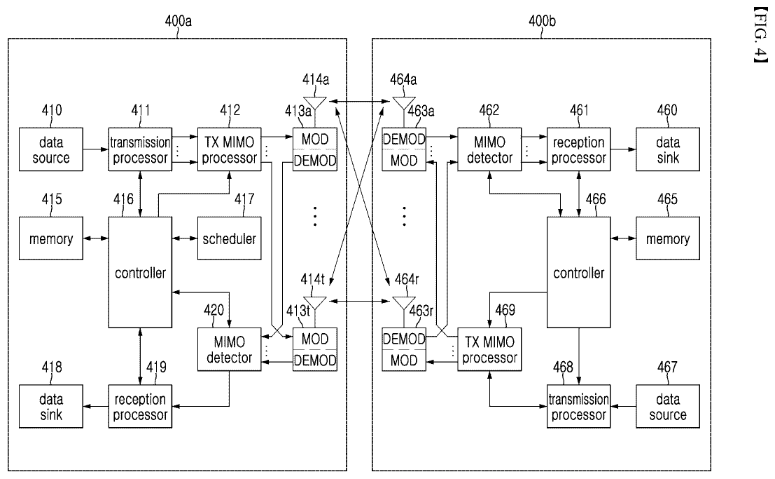

Meanwhile, communication nodes that perform communications in the communication network (e.g. non-terrestrial network) may be configured as follows. A communication node shown in FIG. 4 may be a specific exemplary embodiment of the communication node shown in FIG. 3.

FIG. 4 is a block diagram illustrating a first exemplary embodiment of communication nodes performing communication.

As shown in FIG. 4, each of a first communication node 400a and a second communication node 400b may be a base station or UE. The first communication node 400a may transmit a signal to the second communication node 400b. A transmission processor 411 included in the first communication node 400a may receive data (e.g. data unit) from a data source 410. The transmission processor 411 may receive control information from a controller 416. The control information may include at least one of system information, RRC configuration information (e.g. information configured by RRC signaling), MAC control information (e.g. MAC CE), or PHY control information (e.g. DCI, SCI).

The transmission processor 411 may generate data symbol(s) by performing processing operations (e.g. encoding operation, symbol mapping operation, etc.) on the data. The transmission processor 411 may generate control symbol(s) by performing processing operations (e.g. encoding operation, symbol mapping operation, etc.) on the control information. In addition, the transmission processor 411 may generate synchronization/reference symbol(s) for synchronization signals and/or reference signals.

A Tx MIMO processor 412 may perform spatial processing operations (e.g. precoding operations) on the data symbol(s), control symbol(s), and/or synchronization/reference symbol(s). An output (e.g. symbol stream) of the Tx MIMO processor 412 may be provided to modulators (MODs) included in transceivers 413a to 413t. The modulator may generate modulation symbols by performing processing operations on the symbol stream, and may generate signals by performing additional processing operations (e.g. analog conversion operations, amplification operation, filtering operation, up-conversion operation, etc.) on the modulation symbols. The signals generated by the modulators of the transceivers 413a to 413t may be transmitted through antennas 414a to 414t.

The signals transmitted by the first communication node 400a may be received at antennas 464a to 464r of the second communication node 400b. The signals received at the antennas 464a to 464r may be provided to demodulators (DEMODs) included in transceivers 463a to 463r. The demodulator (DEMOD) may obtain samples by performing processing operations (e.g. filtering operation, amplification operation, down-conversion operation, digital conversion operation, etc.) on the signals. The demodulator may perform additional processing operations on the samples to obtain symbols. A MIMO detector 462 may perform MIMO detection operations on the symbols. A reception processor 461 may perform processing operations (e.g. de-interleaving operation, decoding operation, etc.) on the symbols. An output of the reception processor 461 may be provided to a data sink 460 and a controller 466. For example, the data may be provided to the data sink 460 and the control information may be provided to the controller 466.

On the other hand, the second communication node 400b may transmit signals to the first communication node 400a. A transmission processor 469 included in the second communication node 400b may receive data (e.g. data unit) from a data source 467 and perform processing operations on the data to generate data symbol(s). The transmission processor 468 may receive control information from the controller 466 and perform processing operations on the control information to generate control symbol(s). In addition, the transmission processor 468 may generate reference symbol(s) by performing processing operations on reference signals.

A Tx MIMO processor 469 may perform spatial processing operations (e.g. precoding operations) on the data symbol(s), control symbol(s), and/or reference symbol(s). An output (e.g. symbol stream) of the Tx MIMO processor 469 may be provided to modulators (MODs) included in the transceivers 463a to 463t. The modulator may generate modulation symbols by performing processing operations on the symbol stream, and may generate signals by performing additional processing operations (e.g. analog conversion operation, amplification operation, filtering operation, up-conversion operations) on the modulation symbols. The signals generated by the modulators of the transceivers 463a to 463t may be transmitted through the antennas 464a to 464t.

The signals transmitted by the second communication node 400b may be received at the antennas 414a to 414r of the first communication node 400a. The signals received at the antennas 414a to 414r may be provided to demodulators (DEMODs) included in the transceivers 413a to 413r. The demodulator may obtain samples by performing processing operations (e.g. filtering operation, amplification operation, down-conversion operation, digital conversion operation) on the signals. The demodulator may perform additional processing operations on the samples to obtain symbols. A MIMO detector 420 may perform a MIMO detection operation on the symbols. The reception processor 419 may perform processing operations (e.g. de-interleaving operation, decoding operation, etc.) on the symbols. An output of the reception processor 419 may be provided to a data sink 418 and the controller 416. For example, the data may be provided to the data sink 418 and the control information may be provided to the controller 416.

Memories 415 and 465 may store the data, control information, and/or program codes. A scheduler 417 may perform scheduling operations for communication. The processors 411, 412, 419, 461, 468, and 469 and the controllers 416 and 466 shown in FIG. 4 may be the processor 310 shown in FIG. 3, and may be used to perform methods described in the present disclosure.

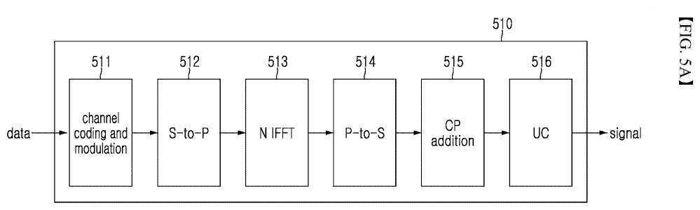

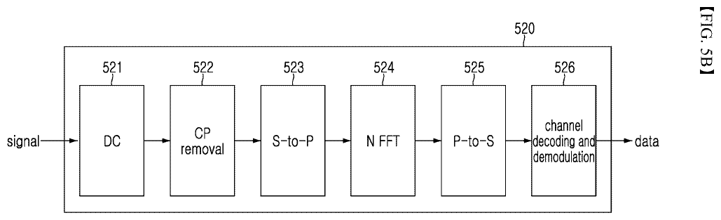

FIG. 5A is a block diagram illustrating a first exemplary embodiment of a transmission path, and FIG. 5B is a block diagram illustrating a first exemplary embodiment of a reception path.

As shown in FIGS. 5A and 5B, a transmission path 510 may be implemented in a communication node that transmits signals, and a reception path 520 may be implemented in a communication node that receives signals. The transmission path 510 may include a channel coding and modulation block 511, a serial-to-parallel (S-to-P) block 512, an N-point inverse fast Fourier transform (N-point IFFT) block 513, a parallel-to-serial (P-to-S) block 514, a cyclic prefix (CP) addition block 515, and up-converter (UC) 516. The reception path 520 may include a down-converter (DC) 521, a CP removal block 522, an S-to-P block 523, an N-point FFT block 524, a P-to-S block 525, and a channel decoding and demodulation block 526. Here, N may be a natural number.

In the transmission path 510, information bits may be input to the channel coding and modulation block 511. The channel coding and modulation block 511 may perform a coding operation (e.g. low-density parity check (LDPC) coding operation, polar coding operation, etc.) and a modulation operation (e.g. Quadrature Phase Shift Keying (OPSK), Quadrature Amplitude Modulation (QAM), etc.) on the information bits. An output of the channel coding and modulation block 511 may be a sequence of modulation symbols.

The S-to-P block 512 may convert frequency domain modulation symbols into parallel symbol streams to generate N parallel symbol streams. N may be the IFFT size or the FFT size. The N-point IFFT block 513 may generate time domain signals by performing an IFFT operation on the N parallel symbol streams. The P-to-S block 514 may convert the output (e.g., parallel signals) of the N-point IFFT block 513 to serial signals to generate the serial signals.

The CP addition block 515 may insert a CP into the signals. The UC 516 may up-convert a frequency of the output of the CP addition block 515 to a radio frequency (RF) frequency. Further, the output of the CP addition block 515 may be filtered in baseband before the up-conversion.

The signal transmitted from the transmission path 510 may be input to the reception path 520. Operations in the reception path 520 may be reverse operations for the operations in the transmission path 510. The DC 521 may down-convert a frequency of the received signals to a baseband frequency. The CP removal block 522 may remove a CP from the signals. The output of the CP removal block 522 may be serial signals. The S-to-P block 523 may convert the serial signals into parallel signals. The N-point FFT block 524 may generate N parallel signals by performing an FFT algorithm. The P-to-S block 525 may convert the parallel signals into a sequence of modulation symbols. The channel decoding and demodulation block 526 may perform a demodulation operation on the modulation symbols and may restore data by performing a decoding operation on a result of the demodulation operation.

In FIGS. 5A and 5B, discrete Fourier transform (DFT) and inverse DFT (IDFT) may be used instead of FFT and IFFT. Each of the blocks (e.g. components) in FIGS. 5A and 5B may be implemented by at least one of hardware, software, or firmware. For example, some blocks in FIGS. 5A and 5B may be implemented by software, and other blocks may be implemented by hardware or a combination of hardware and software. In FIGS. 5A and 5B, one block may be subdivided into a plurality of blocks, a plurality of blocks may be integrated into one block, some blocks may be omitted, and blocks supporting other functions may be added.

Meanwhile, NTN reference scenarios may be defined as shown in Table 1 below.

TABLE 1

| | NTN shown | NTN shown |
|---|---|---|
| | in FIG. 1 | in FIG. 2 |
| GEO | Scenario A | Scenario B |
| LEO (steerable | Scenario C1 | Scenario D1 |
| beams) | | |
| LEO (beams | Scenario C2 | Scenario D2 |
| moving with | | |
| satellite) | | |

When the satellite 110 in the NTN shown in FIG. 1A and/or FIG. 1B is a GEO satellite (e.g. a GEO satellite that supports a transparent function), this may be referred to as ‘scenario A’. When the satellites 211 and 212 in the NTN shown in FIG. 2A, FIG. 2B, and/or FIG. 2C are GEO satellites (e.g. GEOs that support a regenerative function), this may be referred to as ‘scenario B’.

When the satellite 110 in the NTN shown in FIG. 1A and/or FIG. 1B is an LEO satellite with steerable beams, this may be referred to as ‘scenario C1’. When the satellite 110 in the NTN shown in FIG. 1A and/or FIG. 1B is an LEO satellite having beams moving with the satellite, this may be referred to as ‘scenario C2’. When the satellites 211 and 212 in the NTN shown in FIG. 2A, FIG. 2B, and/or FIG. 2C are LEO satellites with steerable beams, this may be referred to as ‘scenario D1’. When the satellites 211 and 212 in the NTN shown in FIG. 2A, FIG. 2B, and/or FIG. 2C are LEO satellites having beams moving with the satellites, this may be referred to as ‘scenario D2’.

Parameters for the NTN reference scenarios defined in Table 1 may be defined as shown in Table 2 below.

TABLE 2

| | Scenarios | Scenarios |
|---|---|---|
| | A and B | C and D |
| Altitude | 35,786 km | 600 km |
| | | 1,200 km |
| Spectrum | < 6 GHz (e.g. 2 GHz) | |
| (service | > 6 GHz (e.g. DL 20 GHz, UL 30 GHz) | |
| link) | | |
| Maximum | 30 MHz for band <6 GHz | |
| channel | 1 GHz for band >6 GHz | |
| bandwidth | | |
| capability | | |
| (service | | |
| link) | | |
| Maximum | 40,581 km | 1,932 km |
| distance | | (altitude |
| between | | of |
| satellite | | 600 km) |
| and | | 3,131 km |
| commun- | | (altitude |
| ication | | of |
| node (e.g. | | 1,200 km) |
| UE) at the | | |
| minimum | | |
| elevation | | |
| angle | | |
| Maximum | Scenario A: 541.46 | Scenario C: |
| round trip | ms | (transparent |
| delay | (service and feeder | payload: |
| (RTD) | links) | service |
| (only | Scenario B: 270.73 | and feeder l |
| propagation | ms | inks) |
| delay) | (only service link) | −5.77 ms |
| | | (altitude of |
| | | 60 0 km) |
| | | −41.77 ms |
| | | (altitude of |
| | | 1,200 km) |
| | | Scenario D: |
| | | (regenerative |
| | | payload: only |
| | | service link) |
| | | −12.89 ms |
| | | (altitude of |
| | | 600 km) |
| | | −20.89 ms |
| | | (altitude of |
| | | 1,200 km) |
| Maximum | 10.3 ms | 3.12 ms |
| differential | | (altitude of |
| delay | | 600 km) |
| within a | | 3.18 ms |
| cell | | (altitude of |
| | | 1,200 km) |
| Service link | NR defined | |
| | in 3GPP | |
| Feeder link | Radio interfaces | |
| | defined in 3GPP | |
| | or non-3GPP | |

In addition, in the scenarios defined in Table 1, delay constraints may be defined as shown in Table 3 below.

TABLE 3

| | Scenario | Scenario | Scenario | Scenario |
|---|---|---|---|---|
| | A | B | C1-2 | D1-2 |
| Satellite | 35,786 km | | 600 km | |
| altitude | | | | |
| Maximum | 541.75 ms | 270.57 ms | 28.41 | 12.88 |
| RTD in a | (worst case) | | ms | ms |
| radio | | | | |
| interface | | | | |
| between | | | | |
| base | | | | |
| station | | | | |
| and UE | | | | |
| Minimum | 477.14 ms | 238.57 ms | 8 | 4 |
| RTD in a | | | ms | ms |
| radio | | | | |
| interface | | | | |
| between | | | | |
| base | | | | |
| station | | | | |
| and UE | | | | |

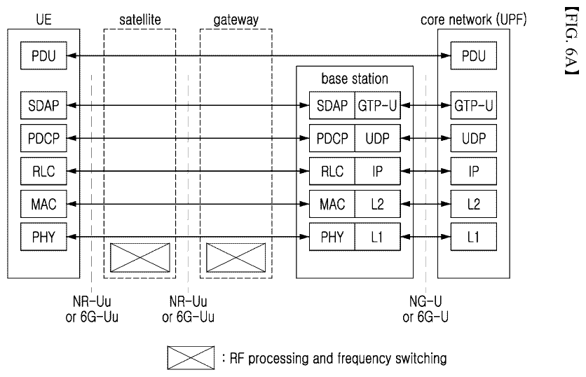

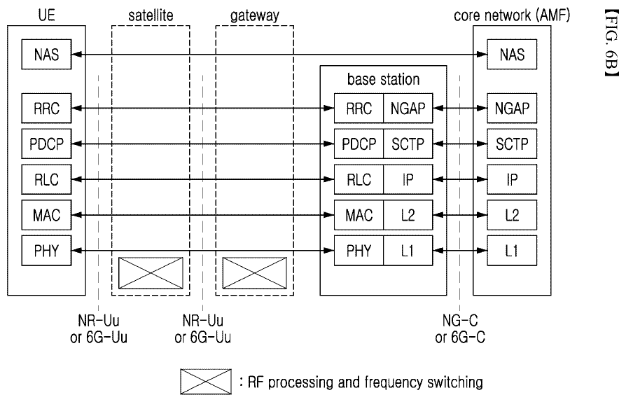

FIG. 6A is a conceptual diagram illustrating a first exemplary embodiment of a protocol stack of a user plane in a transparent payload-based non-terrestrial network, and FIG. 6B is a conceptual diagram illustrating a first exemplary embodiment of a protocol stack of a control plane in a transparent payload-based non-terrestrial network. As shown in FIGS. 6A and 6B, user data may be transmitted and received between a UE and a core network (e.g. UPF), and control data (e.g. control information) may be transmitted and received between the UE and the core network (e.g. AMF). Each of the user data the and control data may be transmitted and received through a satellite and/or gateway. The protocol stack of the user plane shown in FIG. 6A may be applied identically or similarly to a 6G communication network. The protocol stack of the control plane shown in FIG. 6B may be applied identically or similarly to a 6G communication network.

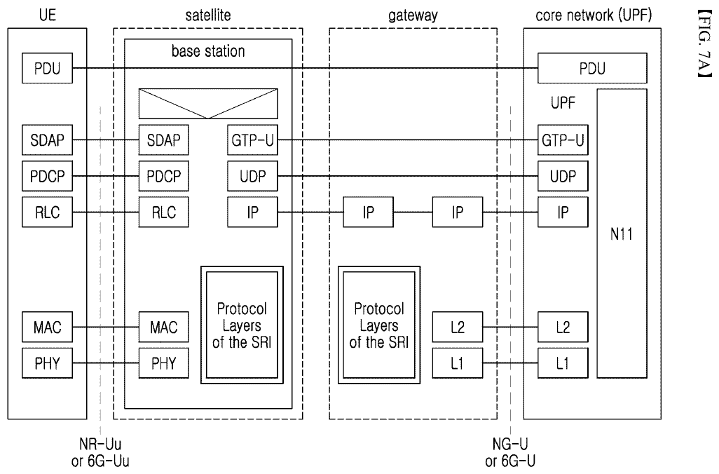

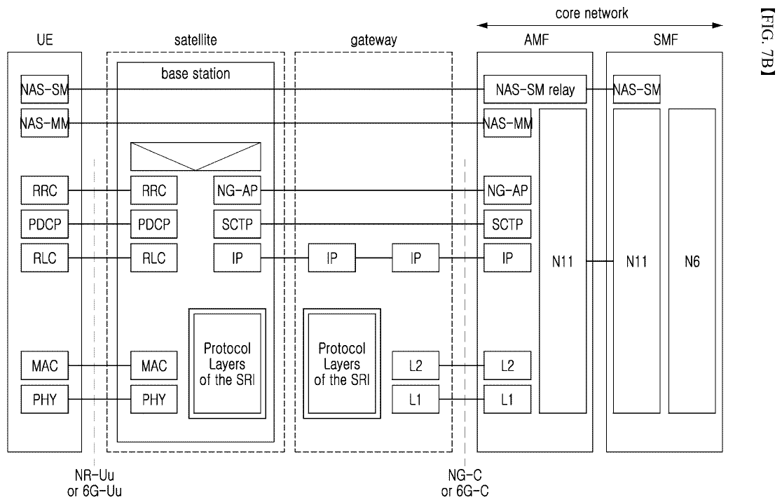

FIG. 7A is a conceptual diagram illustrating a first exemplary embodiment of a protocol stack of a user plane in a regenerative payload-based non-terrestrial network, and FIG. 7B is a conceptual diagram illustrating a first exemplary embodiment of a protocol stack of a control plane in a regenerative payload-based non-terrestrial network.

As shown in FIGS. 7A and 7B, each of user data and control data (e.g. control information) may be transmitted and received through an interface between a UE and a satellite (e.g. base station). The user data may refer to a user protocol data unit (PDU). A protocol stack of a satellite radio interface (SRI) may be used to transmit and receive the user data and/or control data between the satellite and a gateway. The user data may be transmitted and received through a general packet radio service (GPRS) tunneling protocol (GTP)-U tunnel between the satellite and a core network.

Meanwhile, in a non-terrestrial network, a base station may transmit system information (e.g. SIB19) including satellite assistance information for NTN access. A UE may receive the system information (e.g. SIB19) from the base station, identify the satellite assistance information included in the system information, and perform communication (e.g. non-terrestrial communication) based on the satellite assistance information. The SIB19 may include information element(s) defined in Table 4 below.

TABLE 4
SIB19-r17 ::= SEQUENCE {

| | |
|---|---|
| ntn-Config-r17 | NTN-Config-r17 |
| t-Service-r17 | INTEGER(0..549755813887) |
| referenceLocation-r17 | ReferenceLocation-r17 |
| distanceThresh-r17 | INTEGER(0..65525) |
| ntn-NeighCellConfigList-r17 | NTN-NeighCellConfigList-r17 |
| lateNonCriticalExtension | OCTET STRING |

```
  ...,
  [[
```

| | |
|---|---|
| ntn-NeighCellConfigListExt-v1720 | NTN-NeighCellConfigList-r17 |

]]
}

| | |
|---|---|
| NTN-NeighCellConfigList-r17 ::= | SEQUENCE (SIZE(1..maxCellNTN-r17)) |

OF NTN-NeighCellConfig-r17

| | |
|---|---|
| NTN-NeighCellConfig-r17 ::= | SEQUENCE { |
| ntn-Config-r17 | NTN-Config-r17 |
| carrierFreq-r17 | ARFCN-ValueNR |
| physCellId-r17 | PhysCellId |

}

NTN-Config defined in Table 4 may include information element(s) defined in Table 5 below.

TABLE 5

| | |
|---|---|
| NTN-Config-r17 ::= | SEQUENCE { |
| epochTime-r17 | EpochTime-r17 |

ntn-UlSyncValidityDuration-r17 ENUMERATED{ s5, s10, s15, s20, s25, s30, s35,
s40, s45, s50, s55, s60, s120, s180, s240, s900}

| | |
|---|---|
| cellSpecificKoffset-r17 | INTEGER(1..1023) |
| kmac-r17 | INTEGER(1..512) |
| ta-Info-r17 | TA-Info-r17 |
| ntn-PolarizationDL-r17 | ENUMERATED {rhcp,lhcp,linear} |
| ntn-PolarizationUL-r17 | ENUMERATED {rhcp,lhcp,linear} |
| ephemerisInfo-r17 | EphemerisInfo-r17 |
| ta-Report-r17 | ENUMERATED {enabled} |

...
}

| | |
|---|---|
| EpochTime-r17 ::= | SEQUENCE { |
| sfn-r17 | INTEGER(0..1023), |
| subFrameNR-r17 | INTEGER(0..9) |

}

| | |
|---|---|
| TA-Info-r17 ::= | SEQUENCE { |
| ta-Common-r17 | INTEGER(0..66485757), |
| ta-CommonDrift-r17 | INTEGER(−257303..257303) |
| ta-CommonDriftVariant-r17 | INTEGER(0..28949) |

}

EphemerisInfo defined in Table 5 may include information element(s) defined in Table 6 below.

TABLE 6

| | |
|---|---|
| EphemerisInfo-r17 ::= | CHOICE { |
| positionVelocity-r17 | PositionVelocity-r17, |
| orbital-r17 | Orbital-r17 |

}

| | |
|---|---|
| PositionVelocity-r17 ::= | SEQUENCE { |
| positionX-r17 | PositionStateVector-r17, |
| positionY-r17 | PositionStateVector-r17, |
| positionZ-r17 | PositionStateVector-r17, |
| velocityVX-r17 | VelocityStateVector-r17, |
| velocityVY-r17 | VelocityStateVector-r17, |
| velocityVZ-r17 | VelocityStateVector-r17 |

}

| | |
|---|---|
| Orbital-r17 ::= | SEQUENCE { |
| semiMajorAxis-r17 | INTEGER (0..8589934591), |
| eccentricity-r17 | INTEGER (0..1048575), |
| periapsis-r17 | INTEGER (0..268435455), |
| longitude-r17 | INTEGER (0..268435455), |
| inclination-r17 | INTEGER (−67108864..67108863), |
| meanAnomaly-r17 | INTEGER (0..268435455) |

}
PositionStateVector-r17 ::= INTEGER (−33554432..33554431)
VelocityStateVector-r17 ::= INTEGER (−131072..131071)

Meanwhile, as briefly described above, discussions are underway on the NTN specifications at the 3GPP standardization meeting. The discussions related to polarization in NTN are as follows.

When polarization signaling exists in an SIB, in order to indicate right hand circular polarization (RHCP), left hand circular polarization (LHCP), or linear polarization, the SIB may use each polarization type parameter to indicate downlink (DL) and/or uplink (UL) polarization information. Whether polarization signaling is provided for each SSB will be studied further in the future. In addition, polarization signaling for a target serving cell is supported in a handover command message. In addition, polarization signaling for a non-serving cell is supported in radio resource management (RRM) measurement configuration.

First, in the R1 107-e meeting, CMCC proposed various beam layout solutions using frequency and polarization reuse. Second, it was discussed that a satellite using multiple beams can increase a data transmission capability of the satellite compared to a satellite using a single beam. Third, when using multiple beams, interference between beams may occur, and it was discussed that as a measure to alleviate such interference between beams, adjacent beams may be configured to use different frequencies or polarizations. Fourth, in a specific case where beams are distinguished by simultaneously utilizing frequencies and polarizations, strictly speaking, a frequency reuse factor (FRF) cannot be expressed as 4, and is also referred to as a four-color reuse frequency scheme.

First, spatial domain enhancement using polarizations is proposed.

Second, one of NTN-unique characteristics compared to TN should be polarization. Since LHCP and RHCP antennas reject each other's signals, frequency reuse using circular polarization may be used to mitigate inter-cell interference. In addition, LHCP and RHCP signals can be transmitted simultaneously in the same frequency band. Therefore, circular polarizations may be considered as another spatial domain above antenna ports, and circular polarization enhancement for Tx diversity can be further studied.

Then, a frequency reuse factor mentioned above will be described in detail.

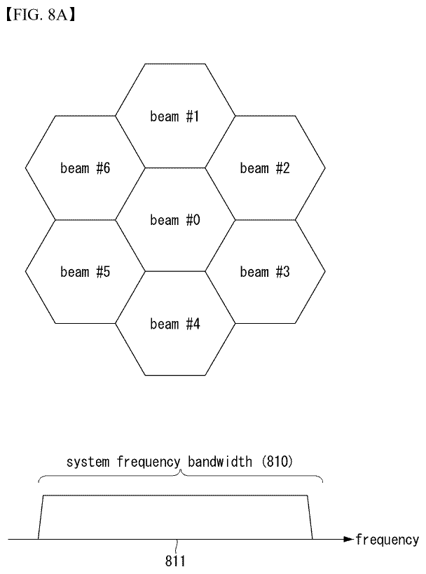

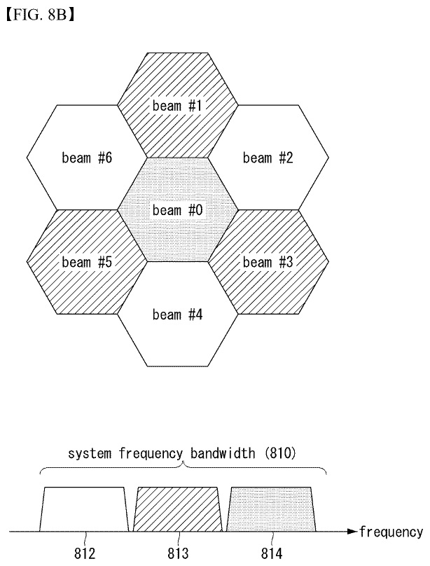

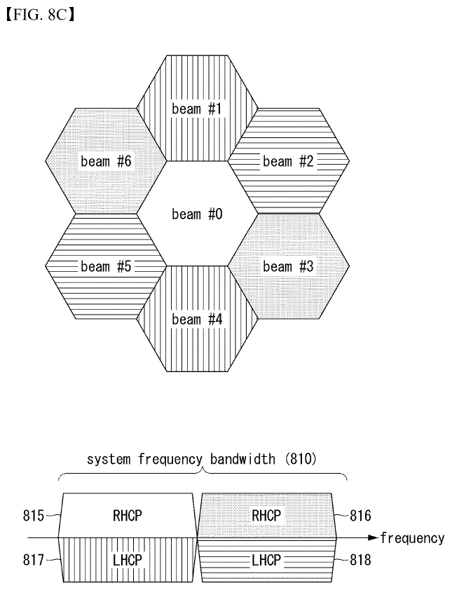

FIG. 8A is a conceptual diagram of a case where a frequency reuse factor is 1, FIG. 8B is a conceptual diagram of a case where a frequency reuse factor is 3, and FIG. 8C is a conceptual diagram of a case where a frequency reuse factor is 4.

As shown in FIG. 8A, coverages of multiple beams, for example, beam #0, beam #1, beam #2, beam #3, beam #4, beam #5, and beam #6, are illustrated. Each of the coverages by the beams #0 to #6 may correspond to one cell. For example, the coverage of beam #0 may correspond to a cell #0, and the coverage of beam #1 may correspond to a cell #1. Accordingly, each of the coverages by beams illustrated in FIG. 8A may be understood as one cell.

In addition, a system frequency bandwidth 810 is illustrated at the bottom of FIG. 8A. In the example of FIG. 8A, each beam may use the entire system frequency bandwidth 810. In this case, since all beams use the entire system frequency bandwidth 810, the frequency reuse factor is 1.

As shown in FIG. 8B, coverages of multiple beams, for example, beam #0, beam #1, beam #2, beam #3, beam #4, beam #5, and beam #6, are illustrated. In FIG. 8B, each of the coverages by beams #0 to #6 may correspond to one cell as in FIG. 8A. Accordingly, the respective coverages by beams illustrated in FIG. 8B may be understood as cells.

The system frequency bandwidth 810 is also illustrated at the bottom of FIG. 8B. In FIG. 8B, unlike the previously described case, a case where the system frequency bandwidth 810 is divided into three subbands is illustrated. In other words, the system frequency bandwidth 810 may be divided into a first subband 812, a second subband 813, and a third subband 814. Each of the beams may use a different subband from adjacent beams. For example, the beams #2, #4, and #6 may use the first subband 812, the beams #1, #3, and #5 may use the second subband 813, and the beam #0 may use the third subband 814. By using different subbands between adjacent beams in the above-described manner, interference between the adjacent beams can be reduced. As shown in FIG. 8B, when the system frequency bandwidth 810 is divided into three subbands and different beams are used between adjacent subbands, the frequency reuse factor is 3.

As shown in FIG. 8C, coverages of multiple beams, for example, beam #0, beam #1, beam #2, beam #3, beam #4, beam #5, and beam #6, are illustrated, similarly to FIG. 8A and FIG. 8B described above, and each of the coverages of beams may be understood as one cell.

The bottom of FIG. 8C illustrates the system frequency bandwidth 810. In FIG. 8C, unlike the previously described case, a case where the system frequency bandwidth 810 is divided into two subbands is illustrated. In addition, a case where RHCP (e.g. 815 or 816) and LHCP (e.g. 817 or 818) are allocated to each subband is illustrated. In other words, beams using a lower frequency band within the system frequency bandwidth 810 may use RHCP 815 and LHCP 817, and beams using a higher frequency band within the system frequency bandwidth 810 may use RHCP 816 and LHCP 818.

For example, the beam #0 may use RHCP 815, the beam #1 and beam #4 may use LHCP 817, the beam #2 and beam #5 may use LHCP 818, and the beam #3 and beam #6 may use RHCP 816. Interference between adjacent beams can be reduced by using different subbands between adjacent beams or using different polarizations in the same subband. In addition, when compared to FIG. 8B, by dividing the system frequency bandwidth 810 into two subbands, there is an effect of increasing a bandwidth usable by one beam.

As in FIG. 8C, when dividing the system frequency bandwidth 810 into two subbands and using different polarizations in one subband, the frequency reuse factor may be 4.

Meanwhile, in 5G communication, a bandwidth part (BWP) smaller than a carrier frequency bandwidth has been introduced due to reasons such as terminal capability, characteristics of traffic to be transmitted, and power consumption reduction by using the carrier frequency band of 400 MHz. Up to four BWPs may be configured for one terminal (e.g. UE), and there is one active BWP.

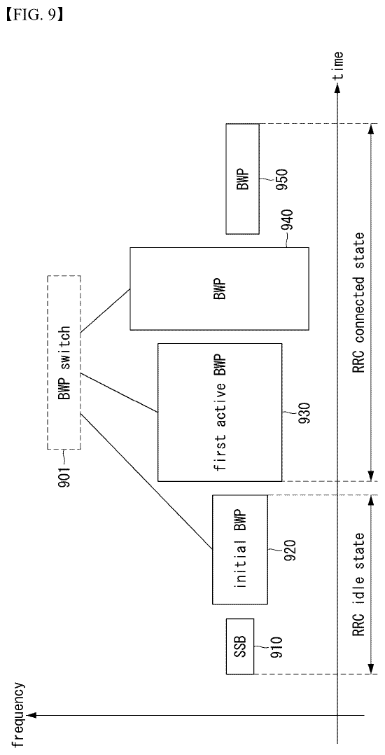

FIG. 9 is a conceptual diagram illustrating a first exemplary embodiment of BWPs used in an RRC idle state and an RRC connected state of a UE.

As shown in FIG. 9, the horizontal axis is a time axis and the vertical axis is a frequency axis. The exemplary embodiment in FIG. 9 may be an exemplary embodiment of a procedure for allocating a BWP to a UE. The UE may receive an initial synchronization signal block (SSB) 910 and obtain information on an initial BWP 920. The SSB 910 may be included in a bandwidth of the initial BWP 920 as illustrated in FIG. 9. The UE may identify the initial BWP 920 based on the information obtained from the SSB 910. As illustrated in FIG. 9, a state in which the UE receives the SSB 910 and acquires the initial BWP 920 based thereon may be an operation performed in the RRC idle state.

Meanwhile, a BWP switch 901 of a base station (e.g. gNB or a satellite and/or a base station connected to a satellite in NTN) is illustrated with a dotted line at the top of FIG. 9. The BWP switch 901 may allocate a first active BWP 930 to the UE when the UE performs a RACH procedure. Therefore, the UE may enter the RRC connected state from a time the first active BWP 930 is allocated to the UE. The UE in the RRC connected state may communicate in the first active BWP 930 allocated by the BWP switch 901. For example, if the first active BWP 930 is a downlink BWP, the UE may receive downlink data from the satellite in the first active BWP 930.

The BWP switch 901 may control switching to a BWP 940 with a wider bandwidth than the first active BWP 930 when necessary while transmitting downlink data. The case of switching to the BWP 940 with a wider bandwidth as described above may be due to factors such as the amount of data or required quality of a service provided to the UE. When switching to the BWP 940 is instructed, the UE may perform BWP switching from the first active BWP 930 to the BWP 940 and receive downlink data from the satellite in the BWP 940.

The BWP switch 901 may control switching to a BWP 950 while transmitting downlink data. When switching to the BWP 950 is instructed, the UE may perform BWP switching from the BWP 940 to the BWP 950 and receive downlink data from the satellite in the BWP 950.

In addition, the RRC connected state may correspond to a time from a time when the UE is allocated the first active BWP 930 and starts receiving downlink data to a time when the UE is allocated the BWP 950 and receives downlink data.

The BWP switching operation described above will be further described.

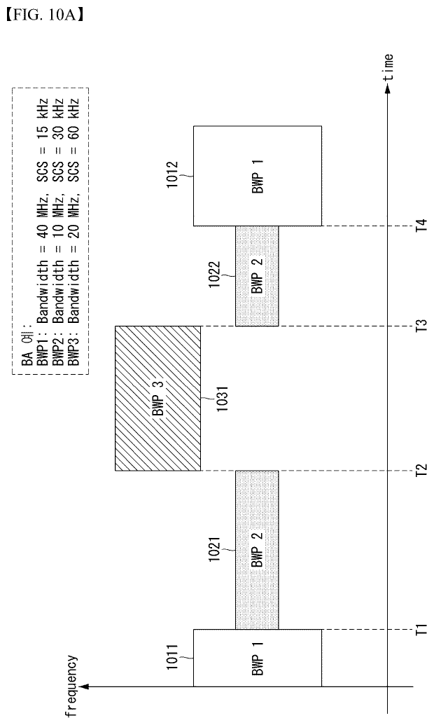

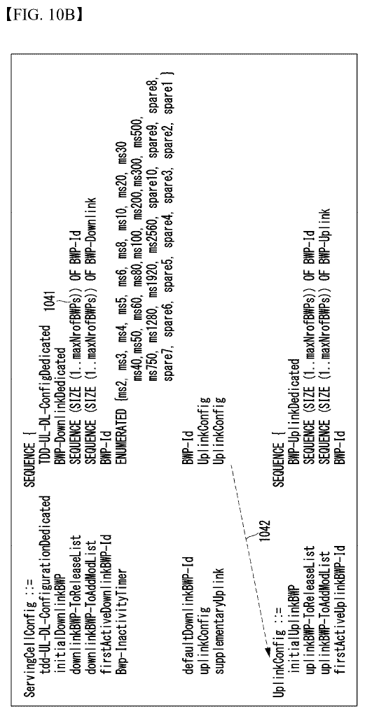

FIG. 10A is an exemplary diagram describing BWP switching with three BWPs.

Before referring to FIG. 10A, since the present disclosure describes operations in NTN, description will be made assuming that an entity controlling BWP switching is a satellite. However, in case of a transparent-payload based NTN, operations performed in a satellite described in the present disclosure may be operations in a base station connected to a gateway on the ground. It should be noted that this applies equally to all operations described below as well as FIG. 10A.

As shown in FIG. 10A, the horizontal axis is a time axis and the vertical axis is a frequency axis. First, a satellite may allocate a BWP1 1011 to a UE. Therefore, the UE may communicate using the BWP1 1011 allocated by the satellite. As illustrated in the upper right of FIG. 10A, the BWP1 may have a bandwidth of 40 MHz and a subcarrier spacing (SCS) of 15 kHz.

Then, the satellite may allocate a BWP2 1021 to the UE at a time T1. In other words, the satellite may instruct BWP switching to allocate the BWP2 1021 to the UE using the BWP1 1011 at the time T1. If the satellite instructs to use the BWP2 1021, the UE may communicate using the BWP2 1021 from the time T1. As illustrated in the upper right of FIG. 10A, the BWP2 may have a bandwidth of 10 MHz and an SCS of 30 kHz.

In addition, the satellite may allocate a BWP3 1031 to the UE at a time T2. In other words, the satellite may instruct BWP switching to allocate the BWP3 1031 to the UE using the BWP2 1021 at the time T2. If the satellite instructs to use the BWP3 1031 from the time T2, the UE may communicate using the BWP3 1031 from the time T2. As illustrated in the upper right of FIG. 10A, the BWP3 may have a bandwidth of 20 MHz and an SCS of 60 KHz.

The satellite may reallocate the BWP2 1022 to the UE at a time T3. In other words, the satellite may instruct BWP switching to allocate the BWP2 1022 to the UE using the BWP3 1031 at the time T3. If the satellite instructs to use the BWP2 1022 from the time T3, the UE may communicate using the BWP2 1022 from the time T3. Meanwhile, in the example of FIG. 10A, the BWP2 1021 allocated to the UE from the time T1 to time T2 and the BWP2 1022 allocated from the time T3 to a time T4 are the same BWP. Different reference numerals are used for the BWP2 1021 and BWP2 1022 to indicate that the they are allocated to the UE at different times.

In addition, the satellite may reallocate the BWP1 1012 to the UE at the time T4. In other words, the satellite may instruct BWP switching to allocate the BWP1 1012 to the UE using the BWP2 1022 at the time T4. If the satellite instructs to use the BWP1 1012 from the time T4, the UE may communicate using the BWP1 1012 from the time T4. As described above, in the example of FIG. 10A, the BWP1 1011 allocated to the UE until the time T1 and the BWP1 1022 to be used after the time T4 are the same BWP. Different reference numerals are used for the BWP1 1011 and BWP1 1012 in FIG. 10A to indicate that they are allocated to the UE at different times.

In describing FIG. 10A, BWP switching may be controlled by RRC signaling, downlink control information (DCI) transmitted through a physical downlink control channel (PDCCH), and/or an inactivity timer.

As described above, a maximum of four BWPs may be allocated to the UE, but as can be seen in FIG. 10A, each UE may use one BWP at a time. Each BWP may have a different bandwidth, location, and/or SCS.

Meanwhile, the initial BWP described in FIG. 9 may be classified into an initial downlink BWP and an initial uplink BWP. The initial downlink BWP may be configured by a network (e.g. gNB and/or satellite) through a system information block 1 (SIB1) among SIBs or higher layer signaling (e.g. dedicated RRC signaling). In particular, common parameters of an initial downlink BWP of a primary cell (PCell) may be provided through system information. The same may be applied to an initial uplink BWP.

The BWP switching described in FIG. 9 and FIG. 10A may be switching to one of the BWPs configured in advance. Each of the BWPs configured in advance has parameters such as bandwidth, SCS, cyclic prefix (CP), and frequency location. These BWPs may be configured in advance by an RRC message.

FIG. 10B is a diagram illustrating BWP-related configurations in a serving cell configuration information element ServingCellConfig of an RRC message.

As shown in FIG. 10B, a portion of an information element ServingCellConfig for serving cell configuration of the 3GPP technical specification TS 38.331 is illustrated. ServingCellConfig may be used to configure a UE with a serving cell, which may be an SpCell or SCell of a master cell group (MCG) or a secondary cell group (SCG). In particular, maxNrofBWPs indicated by a reference numeral 1041 refers to the maximum number of downlink BWPs, and as described above, up to four BWPs may be configured. In addition, a dotted arrow indicated by a reference numeral 1042 is intended to indicate fields related to information related to uplink configuration and supplementary uplink configuration.

In ServingCellConfig of TS 38.331, additional configurations for other information as well as downlink BWPs and uplink BWPs are included, but it should be noted that only a portion related to downlink BWPs and uplink BWPs are illustrated in FIG. 10B.

In the above, the BWPs specified in the 3GPP standard, not a BWP related to NTN, have been described. In NTN, as previously described, the issue of polarization characteristics needs to be additionally considered.

If polarization is not a BWP-specific attribute, the base station or satellite may needs to inform a UE of polarization type(s) through additional signaling. In addition, when performing polarization multiplexing, a problem may arise where polarization signaling is required for each UE. Therefore, it is expected that a situation in which the polarization is operated as a BWP-specific attribute will be given priority. In addition, in this situation, in order to support polarization multiplexing, a change in the polarization type and BWP switching according thereto may be required. Specifically, methods are required to support intra-UE polarization-multiplexed transmission and/or inter-UE polarization-multiplexed transmission. As the methods for supporting polarization-multiplexed transmission, there may be polarization switching, BWP switching, polarization reconfiguration, and BWP reconfiguration methods.

In order to support intra-UE polarization-multiplexed transmission within one BWP, a polarization type may need to be indicated for each PDSCH or PUSCH. To this end, the present disclosure will describe methods for switching to a BWP with a different polarization attribute or changing a polarization attribute of a currently used BWP.

In addition, in order to support inter-UE polarization-multiplexed transmission, methods for allocating a BWP to enable polarization-multiplexed transmission support to multiple UEs, and methods for switching or reconfiguring a BWP for inter-UE polarization-multiplexed transmission during transmission will also be described.

A specific UE may use either single-polarization transmission or polarization-multiplexed transmission depending on a data traffic to be transmitted. For example, when a required data transmission rate is low, single-polarization transmission may be used, and when a high data transmission rate is required, the data transmission rate may be increased through polarization-multiplexed transmission. In addition, depending on polarization types supported by a satellite, polarization-multiplexed transmission or single-polarization transmission may be selected. Even in the case of single-polarization transmission, a change in polarization type may be required.

Meanwhile, forms to which polarization characteristics are applicable when the frequency reuse factor (FRF) described in FIGS. 8A to 8C is applied.

The case described in FIG. 8A, in which the entire system frequency bandwidth 810 is applied to cells corresponding to all beams, and the case described in FIG. 8B, in which the system frequency bandwidth 810 is applied to beams as being divided into several different subbands may correspond to a case where polarization types are not defined. However, when not only a frequency band but also a polarization type is used for each cell as in FIG. 8C, a polarization that can be used for each beam may be restricted. Therefore, in the cases of FIG. 8A and FIG. 8B, polarization-multiplexed transmission is possible. However, in the case of FIG. 8C, polarization-multiplexed transmission using multiple polarizations may not be applied because polarization for each beam is limited for the system frequency band 810.

### First Exemplary Embodiment: Polarization Switching Methods for Intra-UE Polarization-Multiplexed Transmission

In the first exemplary embodiment of the present disclosure, polarization switching methods for polarization-multiplexed transmission will be described. As described above, since the present disclosure provides methods for polarization-multiplexed transmission, exemplary embodiments of the present disclosure may be applied to the NTN system in which a polarization type is not specified for each beam, as in FIG. 8A or FIG. 8B. In addition, in the first exemplary embodiment of the present disclosure, for convenience of description, an entity that instructs BWP allocation, BWP switching, and BWP attribute change will be described as a satellite. However, in a transparent-payload based non-terrestrial network, control messages provided by the satellite may be indicated by a gateway on the ground and/or a base station connected to the gateway. Therefore, depending on a configuration of the NTN, the satellite may be interpreted as the gateway and/or the base station connected to the gateway.

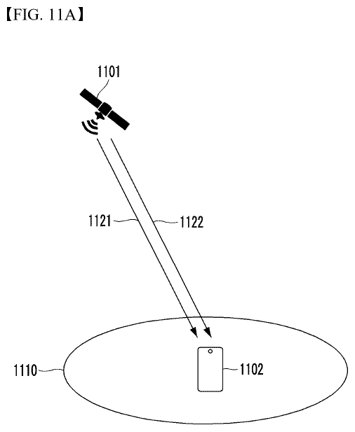

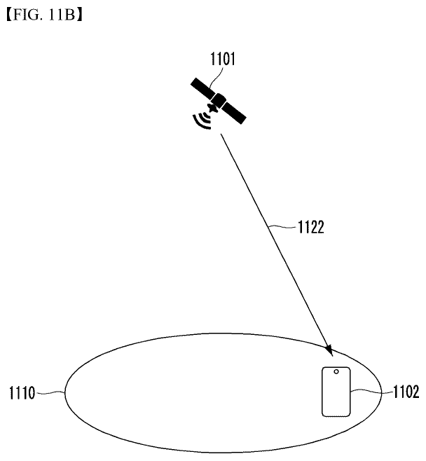

FIG. 11A is a conceptual diagram of a case where a satellite performs polarization-multiplexed transmission to a UE in NTN, and FIG. 11B is a conceptual diagram of a case where a satellite performs single-polarization transmission to a UE in NTN.

First, as shown in FIGS. 11A and 11B, a satellite 1101 and a UE 1102 receiving data via downlink from the satellite 1101 are illustrated. The UE 1102 may be located within a cell 1110 configured by a beam transmitted by the satellite 1101.

In the case of FIG. 11A, the satellite 1101 may perform polarization-multiplexed transmission. For example, the satellite 1101 may transmit downlink data to the UE 1102 using RHCP 1121 and LHCP 1122. RHCP 1121 and LHCP 1122 are known to have no interference with each other due to their different polarized natures. Therefore, the satellite 1101 may transmit the same data or different data to the UE 1102 using RHCP 1121 and LHCP 1122 respectively without interference.

In the case of FIG. 11B, the satellite 1101 may perform single-polarization transmission. For example, the satellite 1101 may transmit data to the UE 1102 using LHCP 1122. FIG. 11B shows an example of transmitting data using only one polarization type. Therefore, although LHCP 1122 is exemplified in FIG. 11B, the case of using only RHCP 1121 can also be understood in the same manner as exemplified in FIG. 11B.

Intra-UE polarization switching and/or BWP switching will be described with reference to FIG. 11A and FIG. 11B.

First, the situation of FIG. 11A may correspond to a state in which the satellite 1101 transmits data to one UE 1102 using RHCP 1121 and LHCP 1122 respectively. The data transmitted using RHCP 1121 and the data transmitted using LHCP 1122 may be different data. Therefore, when the satellite 1101 transmits different data to the UE 1102 using RHCP 1121 and LHCP 1122, higher-speed data transmission may be possible than when only one polarization type is used. In addition, the satellite 1101 may transmit the same data to the UE 1102 using RHCP 1121 and LHCP 1122. In this case, the data may be transmitted more reliably.

While the satellite 1101 transmits data to the UE 1102 using RHCP 1121 and LHCP 1122, there may be a case where one polarization cannot be used or only one polarization should be used. For example, there may be a case where the amount of data to be transmitted to the UE 1102 is small or a case where at least one polarization needs to be allocated to another UE in the same frequency band. When the case where only one polarization should be used occurs while transmitting data to the UE 1102 using RHCP 1121 and LHCP 1122, as in the case of transition from FIG. 11A to FIG. 11B, the satellite 1101 may need to transmit data to the UE 1102 using a single polarization (e.g. LHCP 1122).

On the other hand, while the satellite 1101 transmits data to the UE 1102 using only one polarization type, there may be a case where high-speed data or more reliable data should be transmitted. In this case, the satellite 1101 may need to transmit data to the UE 1102 using both polarization types instead of using only one polarization type. In other words, there may be a case where a situation shown in FIG. 11B in which the satellite 1101 transmits data to the UE 1102 using a single polarization type (e.g. LHCP 1122) needs to transition to a situation shown in FIG. 11A in which the satellite 1101 needs to transmit data to the UE 1102 using both RHCP 1121 and LHCP 1122.

In case of transition from the situation of FIG. 11A to the situation of FIG. 11B or from the situation of FIG. 11B to the situation of FIG. 11A, intra-UE BWP switching may need to be performed. In other words, the satellite may need to instruct the UE to perform switching from a BWP configured to use RHCP 1121 and LHCP 1122 to a BWP configured to use single polarization (e.g. LHCP 1122). In this case, as a method for operating the BWPs, one of the following two methods may be used.

Intra-UE BWP switching method 1: Switching to a BWP with a different polarization attribute

Intra-UE BWP switching method 2: Switching only a polarization attribute of a BWP through DCI signaling

The intra-UE BWP switching method 1 may be correspond to a case where the polarization attribute is defined differently for each BWP. For example, when four BWPs are configured, such as BWP #1, BWP #2, BWP #3, and BWP #4, the polarization attribute need to be defined for each BWP. For example, the BWP #1 may use LHCP and RHCP within a corresponding band, the BWP #2 may use only LHCP within a corresponding band, and each of the BWP #3 and BWP #4 may use only RHCP within a corresponding band.

The intra-UE BWP switching method 2 may correspond to a case where the polarization attribute can be switched for all BWPs. For example, when four BWPs are configured, such as BWP #1, BWP #2, BWP #3, and BWP #4, it may be possible to configure and change LHCP, RHCP, LHCP/RHCP, Horizontal-linear polarization (H-LP), Vertical-linear polarization (V-LP), and Horizontal/Vertical-linear polarization (H/V-LP) for each of the BWPs.

In case of using the intra-UE BWP switching method 1, the BWP switching scheme currently defined in the 3GPP standard may be applied to switching of a BWP based on the use of LHCP and RHCP as is. In other words, the polarization type(s) may be the attribute of the BWP. In this case, in addition to the existing attributes, BWPs may need to have an additional attribute related to supported polarization type(s) such as LHCP, RHCP, LHCP/RHCP, Horizontal-linear polarization (H-LP), Vertical-linear polarization (V-LP), and Horizontal/Vertical-linear polarization (H/V-LP). In the case that polarization attributes needs to be additionally defined for BWPs, it may be difficult that the maximum number (i.e. 4) of BWPs defined in the 3GPP standard provides all possible polarization types. Therefore, in order to support polarization-multiplexed transmission without changing the current technical specifications that support only up to 4 BWPs, the intra-UE BWP switching method 2 may be appropriate.

When using the intra-UE BWP switching method 2, since an active BWP is UE-specific, only a change in polarization attribute is required without changing a frequency location, bandwidth, SCS, etc. of the active BWP. Therefore, the satellite may change a type of polarization transmitted to the UE by signaling only a change in polarization attribute of the BWP through DCI signaling. In this case, the change in polarization attribute may include a case where the polarization attribute is changed from single polarization to dual polarization or from dual polarization to single polarization, and a case where a polarization type (e.g. LHCP or RHCP) is changed for single polarization.

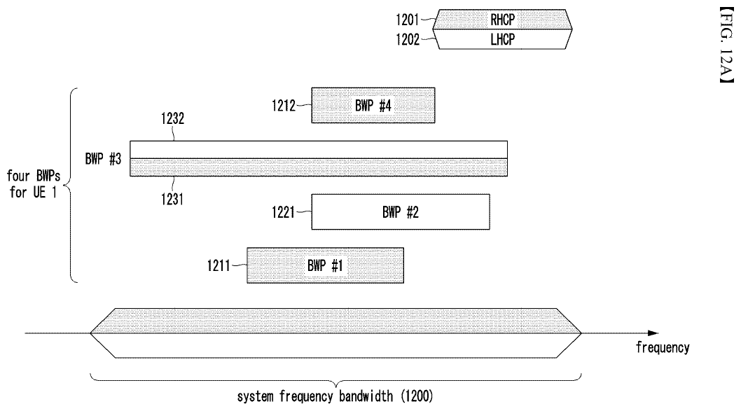

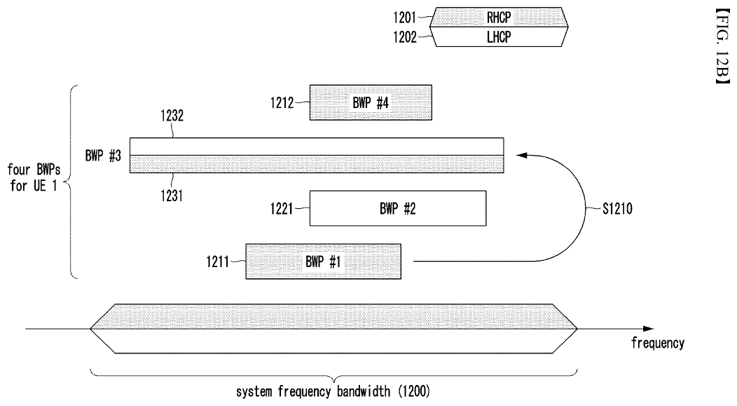

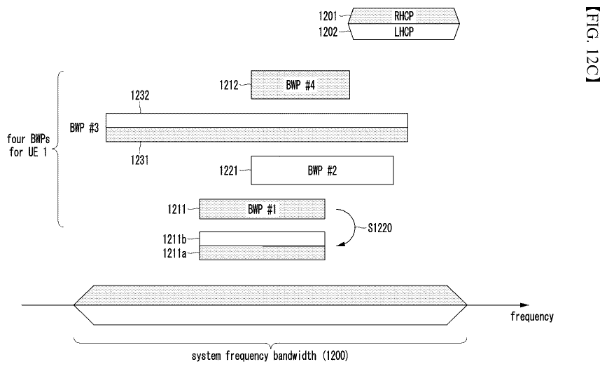

FIG. 12A is a conceptual diagram of a case where four BWPs are allocated to UE1, FIG. 12B is a conceptual diagram of a case where switching is performed to a BWP having a different polarization attribute, and FIG. 12C is a conceptual diagram of a case where only a BWP polarization attribute is switched through DCI signaling.

For convenience of description in the following, the cases of FIG. 12A to 12C will be assumed as cases for downlink. However, the same may be applied to uplink as well based on methods described below.

First, as shown in FIG. 12A, the horizontal axis is a frequency axis. The upper part of FIG. 12A illustrates an example so that RHCP 1201 and LHCP 1202 are identifiable. Based on these, the frequency axis illustrated at the lower part of FIG. 12A also illustrates an example so that RHCP and LHCP are identifiable. In other words, within a bandwidth 1200, RHCP and LHCP can be transmitted. Four BWPs of a UE 1 are illustrated as a BWP #1 1211, BWP #2 1221, BWP #3 1231 and 1232, and BWP #4 1212. As illustrated in FIG. 12A, each of the BWP #1 1211, BWP #2 1221, BWP #3 1231 and 1232, and BWP #4 1212 may have a different frequency band. In other words, the BWP #1 1211, BWP #2 1221, BWP #3 1231 and 1232, and BWP #4 1212 may have partially-overlapped bands, but the BWPs may be configured to have different bands.

In the example of FIG. 12A, the BWP #1 1211, the BWP #3 1231 (i.e. the lower part among the two parts 1231 and 1232), and the BWP #4 1212 may be configured with RHCP, and the BWP #2 1221 and the BWP #3 1232 (i.e. the upper part among the two parts 1231 and 1232) and the BWP #3 1232 may be configured with LHCP.

The UE 1 may receive signals transmitted by the satellite based on RHCP when communicating with the satellite using the BWP #1 1211 or BWP #4 1212. In addition, the UE 1 may receive signals transmitted by the satellite based on LHCP when communicating with the satellite using the BWP #2 1221. In addition, the UE 1 may receive signals transmitted by the satellite based on RHCP and/or LHCP when communicating with the satellite using the BWP #3 1231 and 1232. The above description assumes downlink, but the same may be applied to uplink.

The four BWPs illustrated in FIG. 12A may be configured by the RRC message as described above, and show the case where the maximum number 4 of BWPs that can be allocated to one UE is satisfied as defined in the 3GPP standard.

As shown in FIG. 12B, a case where four BWPs are configured for the UE 1 as described above in FIG. 12A is illustrated. The UE 1 may receive downlink data through the BWP #1 1211. In other words, the satellite may transmit data to the UE 1 through the BWP #1 1211. In this case, the BWP #1 may be a BWP that uses only RHCP.

The satellite may need to switch the BWP to a BWP using LHCP for the UE 1. For example, when transmitting downlink data in the BWP #1 1211 allocated to the UE 1, if a channel condition becomes poor and/or interference becomes severe, the satellite may determine switching from the current BWP #1 1211 for transmitting the downlink data for the UE 1 to another BWP.

In this case, since the BWP #1 1211 uses RHCP among polarization types, the satellite may determine switching to another BWP using LHCP. As illustrated in FIG. 12B, the satellite may determine switching to the BWP #3 1232 using LHCP for the UE 1. Based on this, the satellite may instruct the UE 1 to perform the BWP switching. For example, the satellite may instruct the UE 1 to perform the BWP switching by transmitting an RRC reconfiguration message or DCI. The operation of the satellite instructing the UE 1 to perform BWP switching is exemplified as step S1210. Then, the UE 1 may receive downlink data through the BWP #3 1232 from a time configured based on the instruction of the RRC reconfiguration message or DCI.

The BWP switching method described in FIG. 12B may correspond to the case of switching to a BWP having a different polarization attribute, which is the intra-UE BWP switching method 1 described above. As can be seen in the example of FIG. 12B, since one BWP needs to be selected among the four BWPs allocated to the UE 1, a BWP having different configurations from those of the currently used BWP may be selected. In other words, the BWP #1 1211 and the BWP #3 1232 have different polarization attributes as well as different allocated bandwidths.

As shown in FIG. 12C, a case where four BWPs are configured for the UE 1 as described above in FIG. 12A is illustrated. The UE 1 may receive downlink data through the BWP #1 1211. In other words, the satellite may transmit data to the UE 1 through the BWP #1 1211. In this case, the BWP #1 may be a BWP that uses only RHCP.

The satellite may need to switch the BWP to a BWP using LHCP for the UE 1. For example, when transmitting downlink data through the BWP #1 1211 allocated to the UE 1, if a channel condition becomes poor and/or interference becomes severe, the satellite may determine to change a polarization type for transmitting downlink data for the UE 1. In other words, the satellite may determine to change the polarization attribute of the BWP #1 1211 that transmits data using RHCP, which is used by the UE 1. In the example of FIG. 12C, the satellite may determine to change the polarization attribute of the BWP #1 1211 using RHCP so that the BWP #1 uses RHCP and LHCP. Based on this, the satellite may instruct the UE 1 to change the polarization attribute in step S1220. When the satellite instructs the UE 1 to change the polarization attribute, the change instruction may use a higher layer message (e.g. RRC reconfiguration message) or DCI. However, when reconfiguring the BWP, the satellite may instruct the UE 1 to reconfigure the BWP using the RRC reconfiguration message.

In the example of FIG. 12C, the UE 1 may be instructed through the RRC message or RRC reconfiguration message to change the BWP #1 1211 using RHCP to use RHCP and LHCP, that is, to change the BWP #1 1211 to a BWP #1 1211a using RHCP and a BWP #1 1211b using LHCP. Unlike the example of FIG. 12C, the satellite may instruct the UE 1 to change the BWP #1 1211 using only RHCP so that the BWP #1 1211 uses only LHCP.

When the BWP #1 is changed from using only RHCP to using RHCP and LHCP, the satellite may instruct the UE 1 to perform polarization switching. In other words, while allowing the UE 1 to continue to receive downlink data in the BWP #1, the satellite may instruct the UE1 to change the polarization type from RHCP to LHCP. After changing the polarization attribute of BWP as described above, when the satellite instructs the UE 1 to change polarization type of the downlink, the satellite may change only the polarization attribute of the BWP through DCI signaling described in the intra-UE BWP switching method 2. In the case of intra-UE BWP switching method 2, the Active BWP may have an advantage of maintaining the same BWP attributes excluding the polarization attribute.

### Second Exemplary y Embodiment: Inter-UE Polarization-Multiplexed Transmission Support Methods

Hereinafter, methods for supporting inter-UE polarization-multiplexed transmission will be described. In the second exemplary embodiment of the present disclosure, for convenience of description, an entity instructing BWP allocation, BWP switching, and BWP attribute change will be described as a satellite. However, in a transparent payload-based NTN, control messages provided by the satellite may be indicated by a gateway on the ground and/or a base station connected to the gateway. Therefore, depending on a configuration of the NTN, the satellite may be interpreted as the gateway and/or the base station connected to the gateway.

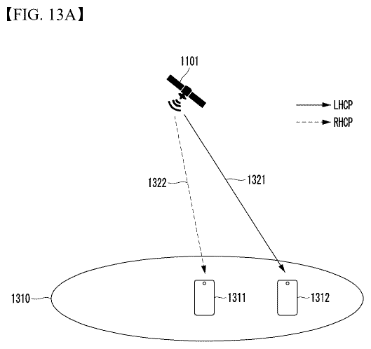

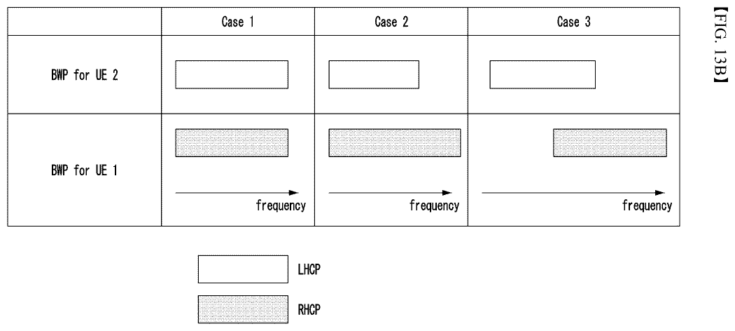

FIG. 13A is a conceptual diagram describing a method for supporting inter-UE polarization-multiplexed transmission in NTN.

As shown in FIG. 13A, a satellite 1301, and a UE 1 1311 and a UE 2 1312 receiving data via downlink from the satellite 1301 are illustrated. The UE 1 1311 and the UE 2 1312 may be located within a cell 1310 configured by a beam transmitted by the satellite 1301.

In the case of FIG. 13A, the satellite 1301 may perform polarization-multiplexed transmission. For example, the satellite 1301 may transmit downlink data to the UE 1 1311 and UE 2 1312 respectively using RHCP 1322 and LHCP 1321. As described above, RHCP 1322 and LHCP 1322 are known to have no interference with each other due to their different polarized natures. Therefore, the satellite 1301 may transmit the downlink data to the UE 1 1311 and UE 2 1312 respectively using RHCP 1322 and LHCP 1321 without interference.

FIG. 13B is a conceptual diagram describing allocation of BWPs during inter-UE polarization-multiplexed transmission in NTN.

As shown in FIG. 13B, three different cases are illustrated for each of the UE 1 and UE 2. Case 1 may correspond to an example in which BWPs respectively allocated to the UE 1 and UE 2 are the same. In other words, frequency bands allocated to the UE 1 and UE 2 may perfectly match each other. Even in Case 1 of FIG. 13B, if downlink data is respectively transmitted to the UE 1 and UE 2 using different polarizations as described in FIG. 13A, transmission without interference is possible.

Case 2 may correspond to an example in which the BWP allocated to the UE 1 is wider than the BWP allocated to the UE 2 and includes the entire BWP allocated to the UE 2. In other words, a frequency bandwidth allocated to the UE 2 may be narrower than the entire frequency bandwidth allocated to the UE 1 and may correspond to a portion of the bandwidth allocated to the UE 1. In Case 2, the case where the BWP allocated to the UE 1 is wider than the BWP allocated to the UE 2 is exemplified, but the opposite case may also be possible. In other words, the case where the BWP allocated to the UE 2 is wider than the BWP allocated to the UE 1 may also be included in Case 2.

Case 3 may correspond to an example where the BWPs allocated to the UE 1 and UE 2 partially overlap. In this case, the frequency bandwidth of the BWP allocated to the UE 1 and the frequency bandwidth allocated to the UE 2 may be the same or different.

Although not illustrated in FIG. 13B, there may also be a case where the bands of the BWPs allocated to the UE 1 and UE 2 do not overlap at all. It should be noted that FIG. 13B is illustrated to describe cases where the bands of the BWPs allocated to the UE 1 and UE 2 overlap.

As described in the examples of FIGS. 13A and 13A, different UEs may exist in the NTN environment, and the BWPs respectively allocated to the UEs may have various forms. In order to perform inter-UE polarization-multiplexed transmission, a scheduling operation is required for configuring appropriate BWPs for the two UEs. The BWP scheduling operation proposed in the present disclosure may include at least some of the following procedures.
Step 1: Provide configuration of a first BWP to which a first polarization is applied to a first UE
Step 2: Provide configuration of a second BWP to which a second polarization is applied to a second UE
Step 3: Transmit a first data/signal to the first UE using a beam with the first polarization applied in the first BWP
Step 4: Transmit a second data/signal to the second UE using a beam with the second polarization applied in the second BWP

In Steps 1 to 4, the first BWP and the second BWP may have overlapped time/frequency resources, and the first data/signal and the second data/signal may be transmitted in the overlapped time/frequency resources.

When transmitting down data in the NTN according to Steps 1 to 5 exemplified above, in other words, UEs in the RRC-connected state may use one of the following methods to perform inter-UE polarization-multiplexed transmission through polarization change.

Inter-UE BWP control method 1: BWP switching for one or more of the two UEs

Inter-UE BWP control method 2: BWP polarization attribute change for one or more of the two UEs

Inter-UE BWP control method 3: BWP switching after BWP reconfiguration for one or more of the two UEs

Then, inter-UE polarization-multiplexed transmission methods based on the inter-UE BWP control methods 1 to 2 will be described hereinafter.

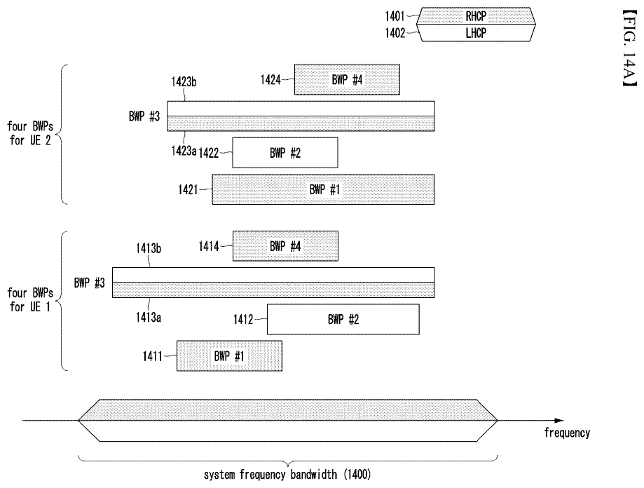

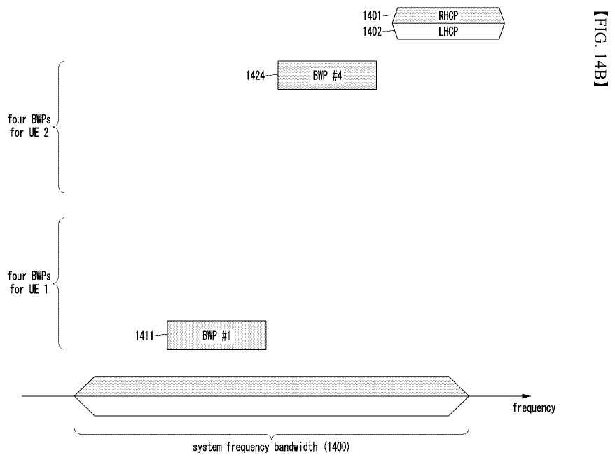

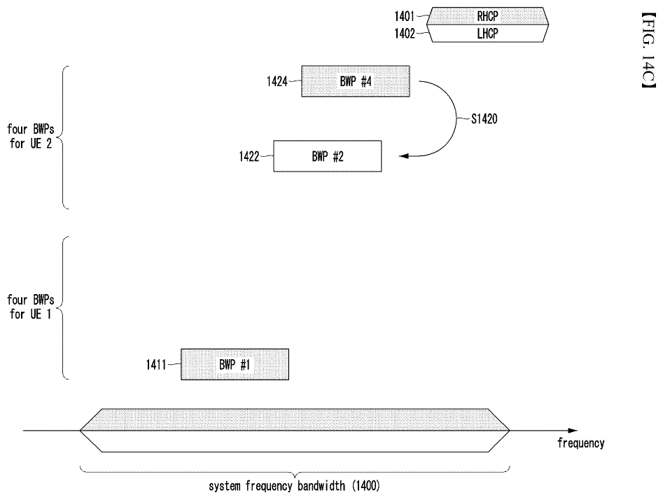

FIG. 14A is an exemplary diagram of a case where four BWPs are allocated to each of UE 1 and UE 2 in NTN.

For convenience of description in the following, cases of FIGS. 14A to 14C will be assumed as cases for downlink. However, the same may be applied to uplink as well based on methods described below.

As shown in FIG. 14A, the horizontal axis is a frequency axis. The upper part of FIG. 14A illustrates an example so that RHCP 1401 and LHCP 1402 are identifiable. Based on these, the frequency axis illustrated at the lower part of FIG. 14A also illustrates an example so that RHCP and LHCP are identifiable. In other words, within a bandwidth 1400, RHCP and LHCP can be transmitted.

In addition, four BWPs of the UE 1 are illustrated as a BWP #1 1411, BWP #2 1412, BWP #3 1413a and 1413b, and BWP #4 1414, and four BWPs of the UE 2 are illustrated as a BWP #1 1421, BWP #2 1422, BWP #3 1423a and 1423b, and BWP #4 1424.

As illustrated in FIG. 14A, the BWP #1 1411, BWP #2 1412, BWP #3 1413a and 1413b, and BWP #4 1414 of the UE 1 may have different frequency bandwidths and utilize different polarizations. In addition, the BWP #1 1421, BWP #2 1422, BWP #3 1423a and 1423b, and BWP #4 1424 of the UE 2 may have different frequency bandwidths and utilize different polarizations.

In addition, the BWP #1 1411, BWP #2 1412, BWP #3 1413a and 1413b, and BWP #4 1414 of the UE 1 may have different bandwidths than the BWP #1 1421, BWP #2 1422, BWP #3 1423a and 1423b, and BWP #4 1424 of the UE 2, respectively. This may correspond to either one of Case 2 and/or Case 3 described in FIG. 13B, or another case in which there is no overlapped frequency band.

In addition, in the example of FIG. 14a, the BWP #1 1411, BWP #3 1413a (i.e. the lower part among the two parts 1413a and 1413b), and BWP #4 1414 of the UE 1 may be BWPs that use RHCP, and the BWP #2 1412 and BWP #3 1413b (i.e. the upper part among the two parts 1413a and 1413b) of the UE 1 may be BWPs that uses LHCP. In addition, the BWP #1 1421, BWP #3 1423a (i.e. the lower part among the two parts 1423a and 1423b), and BWP #4 1424 of the UE2 may be BWPs that use RHCP, and the BWP #2 1422 and BWP #3 1423b (i.e. the upper part among the two parts 1423a and 1423b) of the UE 2 may be BWPs that use LHCP.

FIG. 14B is an exemplary diagram describing a case where UE 1 and UE 2 communicate in specific BWPs in NTN.

Before referring to FIG. 14B, even if four BWPs are allocated to each of the UE 1 and UE 2 as in FIG. 14A, each of the UE 1 and UE 2 may communicate in one BWP during communication. Therefore, as illustrated in FIG. 14B, the UE 1 may receive downlink data from the satellite in the BWP #1 1411, and the UE 2 may receive downlink data from the satellite in the BWP #4 1424. In this case, both the UE 1 and UE 2 may receive downlink data using RHCP. In addition, as illustrated in FIG. 14B, the BWP #1 1411 used by the UE 1 may have a non-overlapped frequency band with the BWP #4 1424 used by the UE 2.

It may be assumed that the case exemplified in FIG. 14B corresponds to a time T1. The BWP to be used by the UE 2 may need to be changed at a time T2. The BWP used at the time T1 and the BWP used at the time T2 may be exemplified as shown in Table 7 below.

TABLE 7

| Method 1 | T1 | T2 |
|---|---|---|
| UE 2 | BWP #4 | BWP #2 |
| UE 1 | BWP #1 | BWP #1 |

Referring to Table 7, the UE 1 may use the BWP #1 at both the times T1 and T2, while the UE 2 uses the BWP #4 at the time T1 and then needs to use the BWP #2 at the time T2. In other words, this may correspond to a case where BWP switching for one or more UEs among the two UEs is required, as in the inter-UE BWP control method 1 described above.

FIG. 14C is an exemplary diagram describing a case where BWP switching is performed in one of UEs in NTN.

FIG. 14C is a diagram for describing a case where BWP switching for the UE 2 is required in a state where four BWPs are allocated to each of the UE 1 and UE 2, the UE 1 receives downlink data from the satellite in the BWP #1 1411, and the UE 2 receives downlink data from the satellite in the BWP #4 1424 as in FIG. 14A.

If BWP switching to the BWP #2 1422 is required for the UE 2 communicating in the BWP #4 1424, the satellite may instruct the UE 2 to perform the BWP switching. The BWP switching may be instructed by DCI. In other words, the satellite may transmit information instructing the BWP switching to the BWP #2 1422 by including it in DCI transmitted to the UE 2 communicating in the BWP #4 1424.

The BWP #2 1422 may be a BWP that communicates using LHCP, and the BWP #4 1424 may be a BWP that communicates using RHCP. Therefore, even if a band of the BWP #1 1411 in which the UE 1 communicates and a band of the BWP #2 1422 in which the UE 2 communicates overlap at least partially at the time T2, interference may be reduced because they use different polarizations.

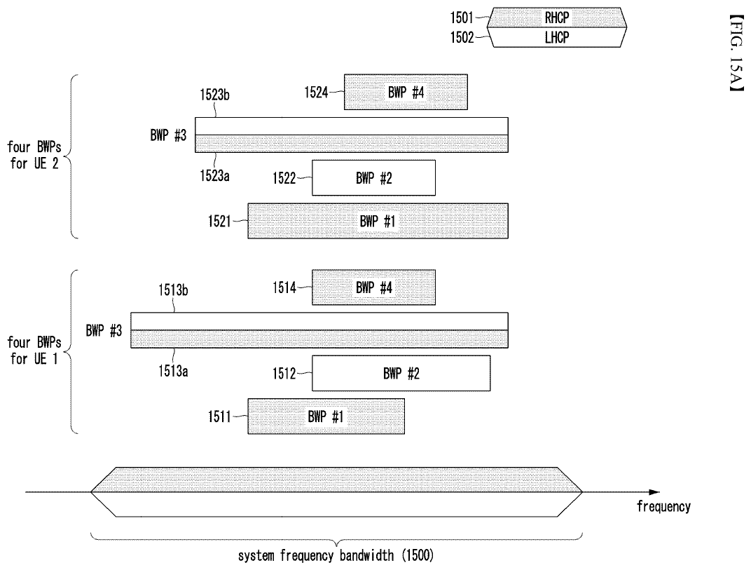

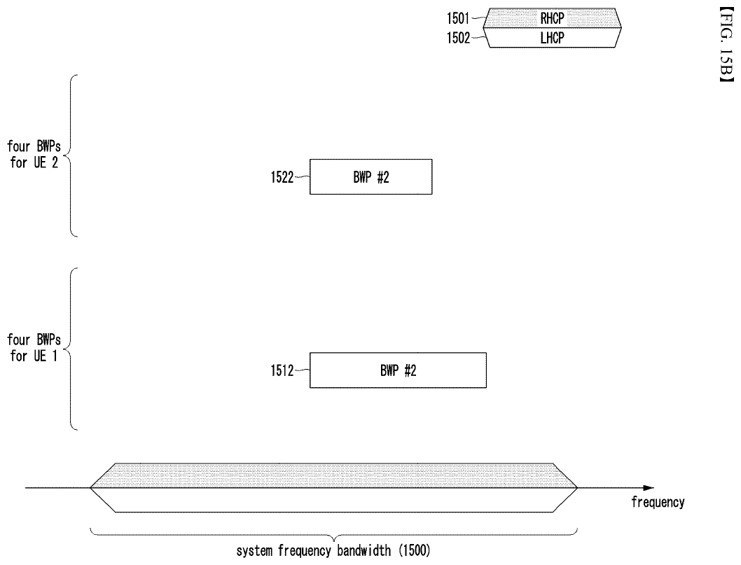

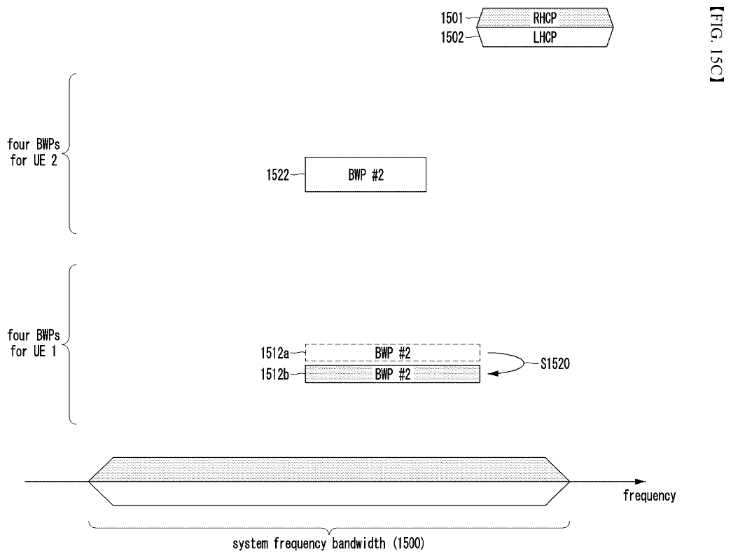

FIG. 15A is another exemplary diagram describing a case where the UE 1 and UE 2 communicate in a specific BWP among four BWPs in NTN.

For convenience of description in the following, cases of FIGS. 15A to 15C will be assumed as cases for downlink. However, the same may be applied to uplink as well based on methods described below.

As shown in FIG. 15A, the horizontal axis is a frequency axis. The upper part of FIG. 15A illustrates an example so that RHCP 1501 and LHCP 1502 are identifiable. Based on these, the frequency axis illustrated at the lower part of FIG. 15A also illustrates an example so that RHCP and LHCP are identifiable. In other words, within a bandwidth 1500, RHCP and LHCP can be transmitted.

In addition, four BWPs of the UE 1 are illustrated as a BWP #1 1511, BWP #2 1512, BWP #3 1513a and 1513b, and BWP #4 1514, and four BWPs of the UE 2 are illustrated as a BWP #1 1521, BWP #2 1522, BWP #3 1523a and 1523b, and BWP #4 1524.

As illustrated in FIG. 15A, the BWP #1 1511, BWP #2 1512, BWP #3 1513a and 1513b, and BWP #4 1514 of the UE 1 may have different frequency bandwidths and may utilize different polarizations. In addition, the BWP #1 1521, BWP #2 1522, BWP #3 1523a and 1523b, and BWP #4 1524 of the UE 2 may have different frequency bandwidths and may utilize different polarizations. In addition, FIG. 15A also illustrates a case where the BWPs allocated to the UE 1 and the BWPs allocated to the UE 2 have different frequency bandwidths as described above in FIG. 14A,

In addition, in the example of FIG. 15A, the BWP #1 1511, BWP #3 1513a, and the BWP #4 1514 of the UE 1 and the BWP #1 1521, BWP #3 1523a, and BWP #4 1524 of the UE 2 may use RHCP 1501, and the BWP #2 1512 and BWP #3 1513b of the UE 1 and the BWP #2 1522 and BWP #3 1523b of the UE may use LHCP.

FIG. 15B is another exemplary diagram describing a case where UE 1 and UE 2 communicate in specific BWPs in NTN.

As described above, even when four BWPs are allocated to each of the UE 1 and UE 2, each of the UE 1 and UE 2 may communicate in one BWP during communication. Therefore, as illustrated in FIG. 15B, the UE 1 may receive downlink data from the satellite in the BWP #2 1512, and the UE 2 may receive downlink data from the satellite in the BWP #2 1522. In this case, both the UE 1 and UE 2 may receive downlink data using LHCP. In addition, as illustrated in FIG. 15B, the BWP #2 1411 used by the UE 1 may have a frequency band that overlaps with the BWP #2 1522 used by the UE 2.

As described above, since BWPs allocated to one UE are UE-specific, even if the same BWP identifier (ID) is used, that is, if the BWP #2 1411 of the UE 1 and the BWP #2 1522 of the UE 2 have the same ID, each ID may indicate the BWP allocated to each UE. As illustrated in FIG. 15B, the BWP #2 1411 of the UE 1 and the BWP #2 1522 of the UE 2 may overlap at least in a partial frequency band and they communicate using the same polarization. Therefore, interference may occur between signals transmitted through the same band between the UE 1 and UE 2. To prevent this, it may be preferable to change the band of the UE 1 or UE 2.

It may be assumed that the case illustrated in FIG. 15B correspond to a time T1. In addition, the BWP to be used by the UE 1 may need to be changed at a time T2. The BWP used at the time T1 and the BWP used at the time T2 may be illustrated as in Table 8 below.

TABLE 8

| Method 2 | T1 | T2 |
|---|---|---|
| UE 2 | BWP #2 (LHCP) | BWP #2 (LHCP) |
| UE 1 | BWP #2 (LHCP) | BWP #2 (RHCP) |

Referring to Table 8, both the UE 1 and UE 2 may use the BWP #2 at the times T1 and T2. Here, the UE 2 may use the same polarization at the times T1 and T2. However, the UE 1 may use LHCP of the BWP #2 at the time T1, but change the polarization type to RHCP at the time T2. In other words, the polarization attribute of the BWP #2 of the UE 1 is changed. As described above in FIG. 15A, the polarization attribute of the BWP #2 1512 of the UE 1 may be in a state of being configured to LHCP. Therefore, the polarization attribute of the BWP #2 1512 of the UE 1 needs to be changed from LHCP to RHCP.

FIG. 15C is an exemplary diagram describing a case where BWP polarization attribute switching is performed in one of the UEs in NTN.

As shown in FIG. 15C, a case where the UE 2 communicates using LHCP in the BWP #2 1522 is illustrated. Then, the UE 1 may change the polarization attribute of the BWP #2 1512a using LHCP so that the BWP #2 1512b uses RHCP (step S1520). In order for the UE 1 to change the polarization attribute of the BWP #2 1512a from using LHCP to using RHCP, the satellite may instruct the UE 1 to change the polarization attribute of the BWP #2 in advance. The satellite may instruct the UE 1 to change the polarization attribute of the BWP #2 by using one of two methods.

First, the satellite may configure information instructing to change the polarization attribute of the BWP #2 of the UE 1 in DCI and transmit the DCI to the UE 1.

Second, the satellite may include information instructing to change the polarization attribute of the BWP #2 of the UE 1 in an RRC message and transmit the RRC message to the UE 1.

If the change in polarization attribute is instructed for a BWP allocated to the UE using DCI, it may have a slightly different form from the general DCI transmission form. This will be described in more detail below.

The DCI may be generally transmitted on a PDCCH. In this case, the DCI transmitted on the PDCCH may include information related to data transmitted to the corresponding UE among data included in a PDSCH transmitted in a resource consecutive after the PDCCH and/or a resource within a certain time from a time when the DCI is transmitted. For example, the DCI transmitted to the specific UE may include scheduling (physical resource allocation) information for downlink data (e.g. PDSCH), modulation scheme and coding rate information of the corresponding physical resource, etc. In addition, the DCI may further include scheduling (physical resource allocation) information for uplink data (e.g. PUSCH) and information for adjusting an uplink power for power control. Since the present disclosure focuses on the operation of receiving downlink data, further description on uplink-related information will be omitted.

As described above, the DCI may include information on a physical resource transmitted in downlink and modulation scheme and coding rate information applied to the corresponding resource. Accordingly, the UE may receive the DCI, and based on the received DCI, receive data transmitted to itself among data included in the PDSCH, and demodulate and decode the data.

As illustrated in FIG. 15C, if the polarization attribute is changed from the time when the DCI instructing the change of polarization attribute is transmitted according to the present disclosure, a problem where the UE cannot receive the corresponding DCI may occur. For example, if the DCI is transmitted to the UE 1 using RHCP at the time T2, that is, the time when switching to the BWP #2 1512b of the UE 1 is performed, the UE 1 may attempt to receive the DCI in the BWP #2 1512a configured to use LHCP. Therefore, if the satellite does not indicate that the BWP #2 1512a is changed to the BWP #2 1512b at the time T2 in advance through the DCI, the UE 1 may not be able to receive the DCI or PDSCH in the BWP #2 1512b using RHCP. Therefore, even if the DCI is used, the change in polarization attribute may need to be notified in advance before the BWP #2 1512a is changed to the BWP #2 1512b.

Then, the case where an RRC message is used will be described. The RRC message may include an RRC reconfiguration message. If the BWP #2 1512a needs to be changed to the BWP #2 1512b, the satellite may instruct the UE 1 to change the attribute of the BWP #2 from a specific time using an RRC reconfiguration message. Here, the specific time may be T2 described in Table 8.

The UE 1 receiving the RRC message (e.g. RRC reconfiguration message) may perform attribute switching of the BWP #2 1512a configure to LHCP to the BWP #2 1512b using RHCP at the time T2. Then, the UE 1 may receive downlink data in the BWP #2 1512b whose polarization attribute is set to RHCP from the time T2.

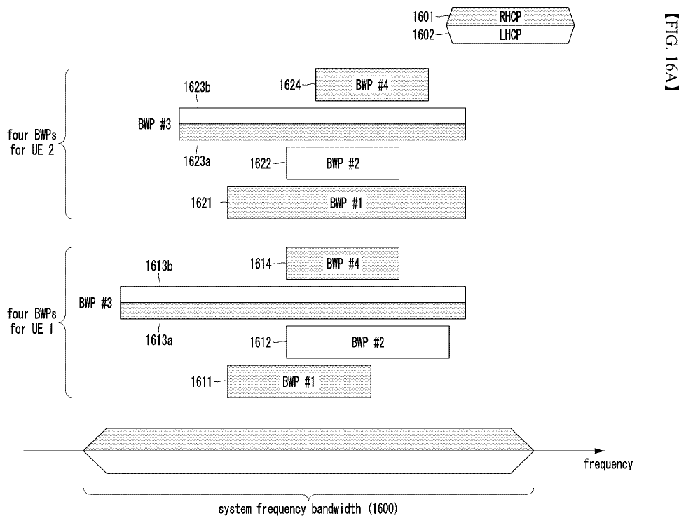

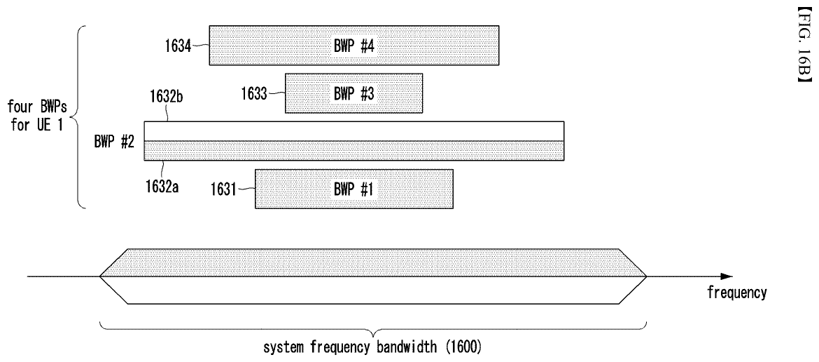

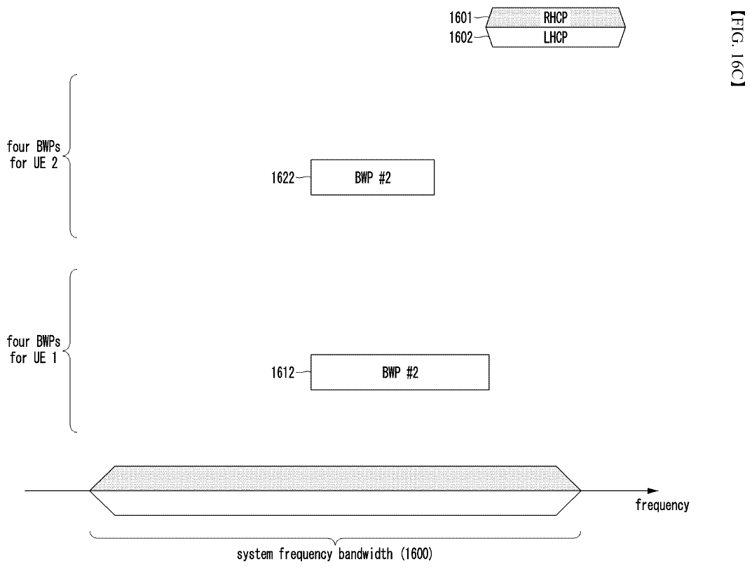

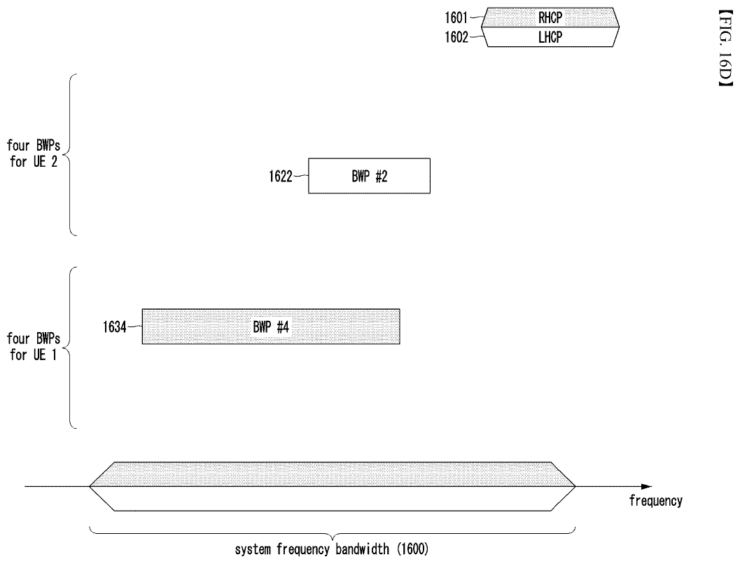

FIG. 16A is an exemplary diagram describing a case where four BWPs are allocated to each of the UE 1 and UE 2 in NTN.

For convenience of description in the following, cases of FIGS. 16A to 16D will be assumed as cases for downlink. However, the same may be applied to uplink as well based on methods described below.

As shown in FIG. 16A, the horizontal axis is a frequency axis. The upper part of FIG. 16A illustrates an example so that RHCP 1601 and LHCP 1602 are identifiable. Based on these, the frequency axis illustrated at the lower part of FIG. 16A also illustrates an example so that RHCP and LHCP are identifiable. In other words, within a bandwidth 1600, RHCP and LHCP can be transmitted.

In addition, four BWPs of the UE 1 are illustrated as a BWP #1 1611, BWP #2 1612, BWP #3 1613a and 1613b, and BWP #4 1614, and four BWPs of the UE 2 are illustrated as a BWP #1 1621, BWP #2 1622, BWP #3 1623a and 1623b, and BWP #4 1624.

In addition, in the example of FIG. 16A, the BWP #1 1611, BWP #3 1613a, and BWP #4 1614 of the UE 1 and the BWP #1 1621, BWP #3 1623a, and BWP #4 1624 of the UE 2 may use RHCP 1601, and the BWP #2 1612 and BWP #3 1613b of the UE 1 and the BWP #2 1622 and BWP #3 1623b of the UE 2 may use LHCP 1602. FIG. 16B is an exemplary diagram describing a case of reconfiguring a BWP of the UE 1 in the NTN.

As shown in FIG. 16B, the four BWPs of the UE 1 described in FIG. 16A, that is, the BWP #1 1611, BWP #2 1612, BWP #3 1613a and 1613b, and BWP #4 1614, may be reconfigured to a BWP #1 1631, BWP #2 1632a and 1632b, BWP #3 1633, and BWP #4 1634 based on BWP reconfiguration.

When the four BWPs allocated to the UE 1 as in FIG. 16A are reconfigured as in FIG. 16B, the BWP reconfiguration may be performed using an RRC reconfiguration message.

FIG. 16C is an exemplary diagram describing a case where the UE 1 and UE 2 communicate in specific BWPs among the BWPs configured as in FIG. 16A.

As described above, even if four BWPs are allocated to each of the UE 1 and UE 2, each of the UE 1 and UE 2 may communicate in one BWP during communication. Therefore, as illustrated in FIG. 16C, the UE 1 may receive downlink data from the satellite in the BWP #2 1612, and the UE 2 may receive downlink data from the satellite in the BWP #2 1622. In this case, both the UE 1 and UE 2 may receive downlink data using LHCP. In addition, as illustrated in FIG. 16B, the BWP #2 1411 used by the UE 1 may have a frequency band that overlaps with the BWP #2 1522 used by the UE 2.

Therefore, when the BWP #2 1612 used by the UE 1 and BWP #2 1622 used by the UE 2 use the same polarization and their frequency bands overlap at least partially as shown in FIG. 16C, the satellite may reconfigure BWPs for one UE among the UE 1 and UE 2. For example, the BWPs for the UE 1 may be reconfigured as shown in FIG. 16B.

FIG. 16B of the present disclosure exemplifies the case where the BWPs of the UE 1 are reconfigured, but the BWPs of the UE 2 may be reconfigured. When BWPs for a specific UE are reconfigured, the specific UE may be determined by referring to at least capability of the UEs, for example, information on a frequency bandwidth that each UE can use. For example, it may be assumed that the UE 1 can use the entire system frequency bandwidth 1600, and the UE 2 can use only a portion of the system frequency bandwidth 1600. In such a case, the UE whose BWPs are reconfigured may be selected based on the information on the frequency bandwidth that each UE can use, which is reported as UE capability information.

In addition, when reconfiguring BWPs for a specific UE as in FIG. 16B, the UE may experience communication interruption, for example, disconnection of the UE's communication, while the BWPs are being reconfigured. Therefore, when reconfiguring BWPs for a specific UE, a Quality of Service (QoS) provided may be considered.

In addition, when reconfiguring BWPs for a specific UE, the UE's communication interruption may occur. Thus, the BWPs of the UE may be reconfigured only when interference occurs with other UEs even in the case of switching to other BWPs.

It may be assumed that the case exemplified in FIG. 16C corresponds to the time T1. At the time T1, the frequency bands of the BWPs used by the UE 1 and UE 2 may overlap, and the same polarization may be used. When the frequency bands of the BWPs used by the UE 1 and UE 2 overlap, and the same polarization is used, BWPs of a specific UE, for example, the UE 1, may be reconfigured, as in FIG. 16B. The BWP used by each of the UE 1 and UE 2 at the time T1 and the BWP used by each of the UE 1 and UE 2 at the time T2 may be changed as shown in Table 9 below.

TABLE 9

| Method 3 | T1 | T2 |
|---|---|---|
| UE 2 | BWP #2(LHCP) | BWP #2(LHCP) |
| UE 1 | BWP #2(LHCP) | BWP #4(RHCP) |

Referring to Table 9, the UE 2 may use the BWP #2 at both the times T1 and T2, and may correspond to a case where no BWP change has occurred. Therefore, the UE 2 may use the BWP #2 at both the times T1 and T2. The BWP #2 may be a BWP using LHCP.

Meanwhile, the UE 1 may communicate in the BWP #2 using LHCP at the time T1. After reconfiguring the BWPs for the UE 1, the BWP #4 may be configured to be used at the time T2. In this case, the BWP #4 used by the UE 1 may be a BWP using RHCP.

FIG. 16D is an exemplary diagram describing a case where BWP switching is performed after BWP reconfiguration in one of the UEs in NTN.

When the BWPs of the UE 1 and UE 2 are configured as in FIG. 16A, and the UE 1 and UE 2 perform communication (e.g. downlink data reception) at a specific time as in FIG. 16C, frequency bands of the BWP #2 1612 for the UE 1 to receive downlink data and the BWP #2 1622 for the UE 2 to receive downlink data may overlap. In addition, both the BWP #2 1612 for the UE 1 to receive downlink data and the BWP #2 1622 for the UE 2 to receive downlink data may use the same polarization, that is, LHCP 1602. In this case, interference may occur between data transmitted to the UE 1 and data transmitted to the UE 2.

Therefore, according to the inter-UE BWP control method 3 of the present disclosure, the BWPs of the UE 1 may be reconfigured as described in FIG. 16B. An RRC reconfiguration message may be used to reconfigure the BWPs of the UE 1. When the BWPs of the UE 1 are reconfigured, the satellite may instruct BWP switching to one (e.g. BWP #4) of the BWPs of the UE 1, as in FIG. 16D. Based on this, the UE 1 may communicate through the BWP #4 1634 from a time when the BWP switching is performed. In this case, the BWP #4 1634 of the UE 1 may be a BWP configured to use RHCP.

Meanwhile, the first and second exemplary embodiments described above have been described by distinguishing intra-UE BWP switching and inter-UE BWP switching for convenience of description. However, the intra-UE BWP switching and inter-UE BWP switching may be performed individually or simultaneously in the NTN.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

1. A method of a satellite, comprising:
in response to a predetermined condition being satisfied while a first user equipment (UE) communicates with the satellite using a first bandwidth part (BWP) among BWPs configured for the first UE, determining BWP switching to communicate using a second BWP;
transmitting a BWP switching instruction message including information of the second BWP to the first UE, based on the determined BWP switching;
switching a BWP for communicating with the first UE from the first BWP to the second BWP; and
communicating with the first UE in the second BWP, based on the BWP switching instruction message,
wherein in each of the BWPs, communication is performed with one of polarization types of a Right Hand Circular Polarization (RHCP), a Left Hand Circular Polarization (LHCP), RHCP/LHCP, a Horizontal-linear polarization (H-LP), a Vertical-linear polarization (V-LP), or a Horizontal/Vertical-linear polarization (H/V-LP).

2. The method according to claim 1, wherein the predetermined condition includes a case where at least a part of a frequency band of a third BWP communicating with a second UE other than the first UE overlaps with the first BWP, and polarization attributes of the third BWP and the first BWP are same.

3. The method according to claim 2, wherein the second BWP is a BWP whose frequency band does not overlap with the third BWP.

4. The method according to claim 1, wherein the first BWP and the second BWP have a same frequency band and different polarization attributes.

5. The method according to claim 1, wherein the BWP switching instruction message is one of a radio resource control (RRC) reconfiguration message or downlink control information (DCI).

6. The method according to claim 1, further comprising:
identifying whether the BWP switching is possible to one of BWPs configured for the first UE when a third BWP of a second UE, other than the first UE, overlaps at least a part of a frequency band of the second BWP and has a same polarization attribute as the second BWP;
reconfiguring the BWPs configured for the first UE when the BWP switching is impossible to any of the BWPs configured for the first UE; and
transmitting a higher layer message including configuration information of the reconfigured BWPs to the first UE.

7. The method according to claim 6, wherein at least one of a frequency bandwidth or polarization attribute of at least one BWP among the reconfigured BWPs is different from that of other BWPs among the reconfigured BWPs.

8. A method of a first user equipment (UE), comprising:
receiving configuration information of bandwidth parts (BWPs) configured for the first UE from a satellite;
receiving a BWP switching instruction message including information of a second BWP while communicating with the satellite using a first BWP included in the BWPs; and
communicating with the satellite in the second BWP based on the BWP switching instruction message,
wherein in each of the BWPs, communication is performed with one of polarization types of a Right Hand Circular Polarization (RHCP), a Left Hand Circular Polarization (LHCP), RHCP/LHCP, a Horizontal-linear polarization (H-LP), a Vertical-linear polarization (V-LP), or a Horizontal/Vertical-linear polarization (H/V-LP).

9. The method according to claim 8, wherein the first BWP and the second BWP have a same frequency band and different polarization attributes.

10. The method according to claim 8, wherein the BWP switching instruction message is one of a radio resource control (RRC) reconfiguration message or downlink control information (DCI).

11. The method according to claim 8, further comprising:
upon receiving a reconfiguration message for the BWPs from the satellite, reconfiguring BWPs capable of communicating with the satellite based on the received reconfiguration message; and
when a third BWP among the reconfigured BWPs is instructed to communicate with the satellite, communicating with the satellite in the third BWP.

12. The method according to claim 11, wherein at least one of a frequency bandwidth or polarization attribute of at least one BWP among the reconfigured BWPs is different from that of other BWPs among the reconfigured BWPs.

13. A satellite comprising a processor,
wherein the processor causes the satellite to perform:
in response to a predetermined condition being satisfied while a first user equipment (UE) communicates with the satellite using a first bandwidth part (BWP) among BWPs configured for the first UE, determining BWP switching to communicate using a second BWP;
transmitting a BWP switching instruction message including information of the second BWP to the first UE, based on the determined BWP switching;
switching a BWP for communicating with the first UE from the first BWP to the second BWP; and
communicating with the first UE in the second BWP, based on the BWP switching instruction message,
wherein in each of the BWPs, communication is performed with one of polarization types of a Right Hand Circular Polarization (RHCP), a Left Hand Circular Polarization (LHCP), RHCP/LHCP, a Horizontal-linear polarization (H-LP), a Vertical-linear polarization (V-LP), or a Horizontal/Vertical-linear polarization (H/V-LP).

14. The method according to claim 13, wherein the predetermined condition includes a case where at least a part of a frequency band of a third BWP communicating with a second UE other than the first UE overlaps with the first BWP, and polarization attributes of the third BWP and the first BWP are same.

15. The method according to claim 14, wherein the second BWP is a BWP whose frequency band does not overlap with the third BWP.

16. The method according to claim 13, wherein the first BWP and the second BWP have a same frequency band and different polarization attributes.

17. The method according to claim 13, wherein the BWP switching instruction message is one of a radio resource control (RRC) reconfiguration message or downlink control information (DCI).

18. The method according to claim 13, wherein the processor further causes the satellite to perform:
identifying whether the BWP switching is possible to one of BWPs configured for the first UE when a third BWP of a second UE, other than the first UE, overlaps at least a part of a frequency band of the second BWP and has a same polarization attribute as the second BWP;
reconfiguring the BWPs configured for the first UE when the BWP switching is impossible to any of the BWPs configured for the first UE; and
transmitting a higher layer message including configuration information of the reconfigured BWPs to the first UE.

19. The method according to claim 18, wherein at least one of a frequency bandwidth or polarization attribute of at least one BWP among the reconfigured BWPs is different from that of other BWPs among the reconfigured BWPs.
